(19) United States
(12) Patent Application Publication
(10) Pub. No.: US 2025/0278291 A1
(43) Pub. Date: Sep. 4, 2025

(54) TRANSACTION PROCESSING METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Zhuguang SHAO, Shenzhen (CN)

(21) Appl. No.: 19/199,925

(22) Filed: May 6, 2025

Related U.S. Application Data
(63) Continuation of application No. PCT/CN2023/131700, filed on Nov. 15, 2023.

(30) Foreign Application Priority Data
Apr. 21, 2023 (CN) 202310442652.X

(51) Int. Cl. G06F 9/46; G06F 11/14

(52) U.S. Cl. CPC G06F 9/466; G06F 11/1471; G06F 2201/84

(57) ABSTRACT

A transaction processing method includes: receiving, by a secondary node, execution information including transaction identification information and write information including a write order of execution results that are transmitted by a primary node; then executing, in parallel, a plurality of transactions corresponding to the transaction identification information, to obtain execution results of the plurality of transactions; and then sequentially writing the execution results of the plurality of transactions into a transaction snapshot of the secondary node in the write order.

### CROSS-REFERENCES TO RELATED APPLICATIONS

This application is a continuation of PCT Application No. PCT/CN2023/131700, filed on Nov. 15, 2023, which claims priority to Chinese Patent Application No. 202310442652X, filed with the China Intellectual Property Administration on Apr. 21, 2023 and entitled “TRANSACTION PROCESSING METHOD AND APPARATUS, DEVICE, AND MEDIUM”, the entire contents of all of which are incorporated herein by reference.

### FIELD OF THE TECHNOLOGY

The present disclosure relates to the field of blockchain technologies, and specifically, to transaction processing technologies in a blockchain.

### BACKGROUND OF THE DISCLOSURE

Nodes are divided into a primary node and a secondary node in a blockchain. The primary node and the secondary node usually have differences in hardware configurations, resource allocation policies, and the like. Therefore, duration required by the primary node and duration required by the secondary node to perform transaction processing are different.

When a plurality of transactions involve write-write conflicts, the primary node may perform the plurality of transactions in parallel, but the duration required by the secondary node and the duration required by the primary node to perform transaction processing are different. To ensure consistency between the execution results finally written by the secondary node into the transaction snapshot of the secondary node and the execution results finally written by the primary node into the transaction snapshot of the primary node, the secondary node needs to execute the plurality of transactions in series. Consequently, transaction processing efficiency of the secondary node is low.

Therefore, how to improve the transaction processing efficiency of the secondary node is a problem that urgently needs to be resolved.

### SUMMARY

Embodiments of the present disclosure provide a transaction processing method and apparatus, a device, and a medium, to improve transaction processing efficiency of a secondary node.

According to a first aspect, an embodiment of the present disclosure provides a transaction processing method, performed by a computer device serving as a primary node, the method including: generating execution information including transaction identification information, the execution information being configured to indicate that a plurality of transactions corresponding to the transaction identification information are to be executed in parallel by a secondary node; generating write information including a write order of execution results, the write information being configured to indicate that execution results of the plurality of transactions are to be sequentially written by the secondary node into a transaction snapshot of the secondary node according to the write order; and transmitting the execution information and the write information to the secondary node.

According to a second aspect, an embodiment of the present disclosure provides a transaction processing method, performed by a computer device serving as a secondary node, the method including: receiving execution information including transaction identification information and write information including a write order of execution results that are transmitted by a primary node; executing, in parallel, a plurality of transactions corresponding to the transaction identification information, to obtain execution results of the plurality of transactions; and sequentially writing the execution results of the plurality of transactions into a transaction snapshot of the secondary node in the write order.

According to a third aspect, an embodiment of the present disclosure provides a transaction processing apparatus, configured in a primary node, the apparatus including: a first generation module, configured to generate execution information including transaction identification information, the execution information being configured to indicate that a plurality of transactions corresponding to the transaction identification information are to be executed in parallel by a secondary node; a second generation module, configured to generate write information including a write order of execution results, the write information being configured to indicate that execution results of the plurality of transactions are to be sequentially written by the secondary node into a transaction snapshot of the secondary node according to the write order; and a transmission module, configured to transmit the execution information and the write information to the secondary node.

According to a fourth aspect, an embodiment of the present disclosure provides a transaction processing apparatus, configured in a secondary node, the apparatus including: a receiving module, configured to receive execution information including transaction identification information and write information including a write order of execution results that are transmitted by a primary node; an execution module, configured to execute, in parallel, a plurality of transactions corresponding to the transaction identification information, to obtain execution results of the plurality of transactions; and a write module, configured to sequentially write the execution results of the plurality of transactions into a transaction snapshot of the secondary node in the write order.

According to a fifth aspect, an embodiment of the present disclosure provides an electronic device, including one or more processors; and a memory, configured to store one or more programs, the one or more programs, when executed by the one or more processors, causing the electronic device to implement the transaction processing method described above.

According to a sixth aspect, an embodiment of the present disclosure provides a non-transitory computer-readable medium, having a computer program stored therein, the computer program, when executed by a processor, implementing the transaction processing method described above.

In the technical solutions provided in the embodiments of the present disclosure, the primary node generates the execution information including the transaction identification information and the write information including the write order of the execution results, and transmits the execution information and the write information to the secondary node.

The secondary node executes, in parallel based on the execution information, the plurality of transactions corresponding to the transaction identification information in the execution information, to obtain the execution results corresponding to the plurality of transactions. In this way, a phenomenon that the secondary node executes, in series, the plurality of transactions corresponding to the transaction identification information, causing low transaction processing efficiency of the secondary node is avoided. That is, the transaction processing efficiency of the secondary node is greatly improved.

The secondary node sequentially writes, based on the write information, the execution results of the plurality of transactions into the transaction snapshot of the secondary node in the write order of the execution results in the write information, to avoid a phenomenon that the execution results written by the secondary node into the transaction snapshot are inconsistent with the execution results written by the primary node into the transaction snapshot, that is, ensure consistency between the execution results of the secondary node in the transaction snapshot and the execution results of the primary node in the transaction snapshot, thereby improving accuracy of the transaction processing.

### BRIEF DESCRIPTION OF THE DRAWINGS

FIG. 1 is a schematic diagram of a structure of a blockchain network.

FIG. 2 is a schematic diagram of a connection relationship of blocks in a blockchain.

FIG. 3 is a schematic diagram of an exemplary transaction processing process of a primary node and an exemplary transaction processing process of a secondary node.

FIG. 4 is a schematic diagram of an exemplary implementation environment to which a technical solution according to an embodiment of the present disclosure is applicable.

FIG. 5 is a schematic diagram of a transaction processing process of a primary node and a transaction processing process of a secondary node according to an exemplary embodiment of the present disclosure.

FIG. 6 is a flowchart of a transaction processing method according to an exemplary embodiment of the present disclosure.

FIG. 7 is a flowchart of a transaction processing method according to another exemplary embodiment of the present disclosure.

FIG. 8 is a flowchart of a transaction processing method according to another exemplary embodiment of the present disclosure.

FIG. 9 is a flowchart of a transaction processing method according to another exemplary embodiment of the present disclosure.

FIG. 10 is an exemplary schematic diagram of repeatedly executing a transaction by a primary node.

FIG. 11 is a flowchart of a transaction processing method according to another exemplary embodiment of the present disclosure.

FIG. 12 is a schematic diagram of a transaction processing process of a primary node and a transaction processing process of a secondary node according to an exemplary embodiment of the present disclosure.

FIG. 13 is a flowchart of a transaction processing method according to another exemplary embodiment of the present disclosure.

FIG. 14 is a flowchart of a transaction processing method according to another exemplary embodiment of the present disclosure.

FIG. 15 is a flowchart of a transaction processing method according to another exemplary embodiment of the present disclosure.

FIG. 16 is a flowchart of a transaction processing method according to an exemplary embodiment of the present disclosure.

FIG. 17 is a flowchart of a transaction processing method according to another exemplary embodiment of the present disclosure.

FIG. 18 is a flowchart of a transaction processing method according to an exemplary embodiment of the present disclosure.

FIG. 19 is a flowchart of a transaction processing method according to another exemplary embodiment of the present disclosure.

FIG. 20 is a flowchart of a transaction processing method according to another exemplary embodiment of the present disclosure.

FIG. 21 is a flowchart of a transaction processing method according to another exemplary embodiment of the present disclosure.

FIG. 22 is a flowchart of a transaction processing method according to another exemplary embodiment of the present disclosure.

FIG. 23 is a flowchart of a transaction processing method according to another exemplary embodiment of the present disclosure.

FIG. 24 is a block diagram of a transaction processing apparatus according to an embodiment of the present disclosure.

FIG. 25 is a block diagram of a transaction processing apparatus according to an embodiment of the present disclosure.

FIG. 26 is a schematic diagram of a structure of a computer system adapted to implement an electronic device according to an embodiment of the present disclosure.

### DESCRIPTION OF EMBODIMENTS

Before technical solutions in embodiments of the present disclosure are described, a blockchain technology used in the embodiments of the present disclosure is described first.

A blockchain is a new application mode of computer technologies such as distributed data storage, point-to-point transmission, a consensus mechanism, and an encryption algorithm. The blockchain is essentially a decentralized database and is a string of data blocks (namely, blocks) generated through association by using a cryptographic method. Each data block includes information of a batch of network transactions. The information is configured for verifying validity of information of the data block (anti-counterfeiting) and generating a next data block. The blockchain may include an underlying blockchain platform, a platform product service layer, and an application service layer.

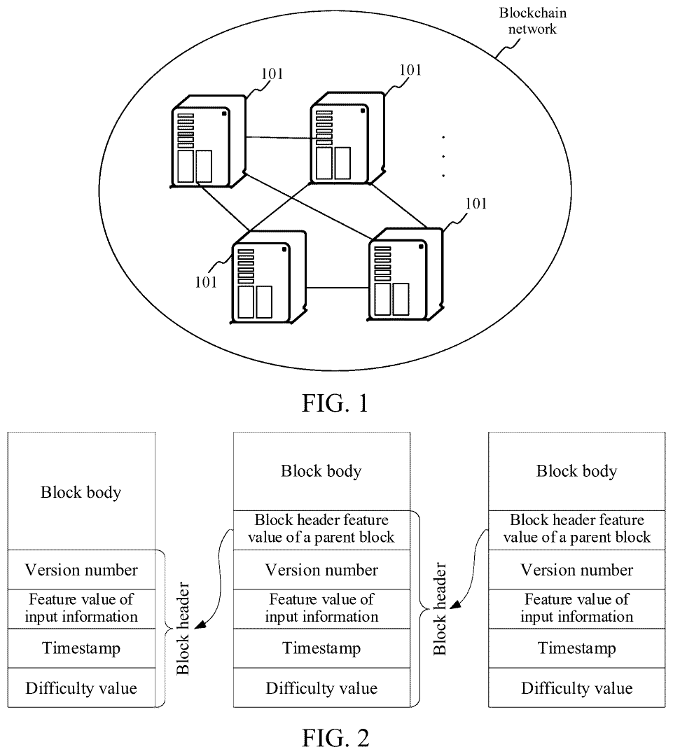

As described above, the blockchain is essentially a decentralized database, and the blockchain is jointly maintained by nodes in a blockchain network. For example, referring to FIG. 1, a blockchain network shown in FIG. 1 may include a plurality of nodes 101, and the plurality of nodes 101 may be clients forming the blockchain network. Each node 101 can receive input information during normal operation, and maintain shared data in the blockchain network based on the received input information. To ensure information intercommunication in the blockchain network, each node in the blockchain network may have an information connection, and the nodes may transmit information through the information connection. For example, when any node device in the blockchain network receives input information, another node in the blockchain network obtains the input information according to a consensus algorithm, and stores the input information as shared data, so that consistent data is stored in all nodes in the blockchain network.

Each node in the blockchain network has a corresponding node identifier, and the each node in the blockchain network may store node identifiers of other nodes, to subsequently broadcast the generated block to the other nodes in the blockchain network according to the node identifiers of the other nodes. Each node may maintain one node identifier list, and store node names and node identifiers correspondingly in the node identifier list. A node identifier may be an internet protocol (IP) address and any other type of information capable of identifying the node.

Each node in the blockchain network stores the same blockchain. The blockchain includes a plurality of blocks. Referring to FIG. 2, the blockchain includes a plurality of blocks, and a founding block includes a block header and a block body. The block header stores an input information feature value, a version number, a timestamp, and a difficulty value. The block body stores input information. A next block of the founding block uses the founding block as a parent block, and also includes a block header and a block body. The block header stores an input information feature value of a current block, a block header feature value of the parent block, a version number, a timestamp, a difficulty value, and the like. The rest is deduced analogy. Block data stored in each block in the blockchain is associated with block data stored in the parent block, thereby ensuring security of the input information in the blocks.

Each node in the blockchain network may be a server, or may be a terminal device. The server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal device may be a smartphone, a tablet computer, a notebook computer, a desktop computer, a smart speaker, a smart watch, or the like, but is not limited thereto. Each node may be directly or indirectly connected in a wired or wireless communication manner. This is not limited in the present disclosure.

The cloud computing refers to a delivery mode and a usage mode of IT infrastructure, which specifically refers to obtaining required resources through the network in an on-demand and easily scalable manner; and broadly defined cloud computing refers to a delivery mode and a usage mode of a service, which refers to obtaining required services through the network in an on-demand and easily scalable manner. The services may be IT, software, internet-related, or other services. The cloud computing is a product of development and integration of computer and network technologies such as grid computing, distributed computing, parallel computing, utility computing, network storage, virtualization, and load balancing. Cloud computing develops rapidly with the development of the internet, a real-time data flow, diversification of connected devices, and a requirement for a search service, a social network, mobile commerce, and open collaboration.

The blockchain is generally divided into three types: a public blockchain, a private blockchain, and a consortium blockchain. In addition, there may be further a combination of the foregoing types, for example, a private blockchain plus a consortium blockchain, or a consortium blockchain plus a public blockchain.

The most decentralized blockchain is the public blockchain. A participant (which may also be referred to as a node in the blockchain network) joining the public blockchain may read a data record in the blockchain, participate in a transaction, compete for an accounting right of a new block, and the like. In addition, each node may freely join or exit the blockchain network, and perform related operations.

On the contrary, for the private blockchain, a write permission of the blockchain network is controlled by an organization, and a data read permission is stipulated by the organization. In short, the private blockchain may be a weakly centralized system, and has a strict limitation on nodes and a relatively small quantity of nodes. This type of blockchain is more suitable for internal use of a particular organization.

The consortium blockchain is a blockchain between the public blockchain and the private blockchain, and may implement “partial decentralization”. Each node in the consortium blockchain usually has a corresponding physical organization. The node joins a network through authorization and forms a consortium related to interest, to jointly maintain operation of the blockchain network.

An intelligent contract is deployed in the foregoing blockchain. The intelligent contract is a computer protocol aimed at propagating, verifying, or executing a contract in an information-based manner. The intelligent contract allows a trusted transaction to be performed without a third party. A specific form of the intelligent contract is code that is deployed in the blockchain to implement a specific function.

A transaction is an operation request of a user on an intelligent contract interface deployed in the blockchain. The transaction is initiated by the user and is transmitted from a client of the user to a node (referred to as a primary node) in the blockchain. After receiving the transaction, the node in the blockchain invokes a corresponding intelligent contract according to a contract address and an interface that are specified by the transaction, and then notifies another node (referred to as a secondary node) of the transaction. After receiving the transaction, the another node invokes the corresponding intelligent contract according to the contract address and the interface that are specified by the transaction.

For the blockchain technology introduced in the foregoing embodiments, the primary node and the secondary node in the blockchain usually have differences in hardware configurations, resource allocation policies, and the like. Therefore, duration required by the primary node and duration required by the secondary node to perform transaction processing are different. When a plurality of transactions involve write-write conflicts, the primary node may perform the plurality of transactions in parallel, but the duration required by the secondary node and the duration required by the primary node to perform transaction processing are different. To ensure consistency between the execution results finally written by the secondary node into the transaction snapshot of the secondary node and the execution results finally written by the primary node into the transaction snapshot of the primary node, the secondary node needs to execute the plurality of transactions in series. Consequently, transaction processing efficiency of the secondary node is low.

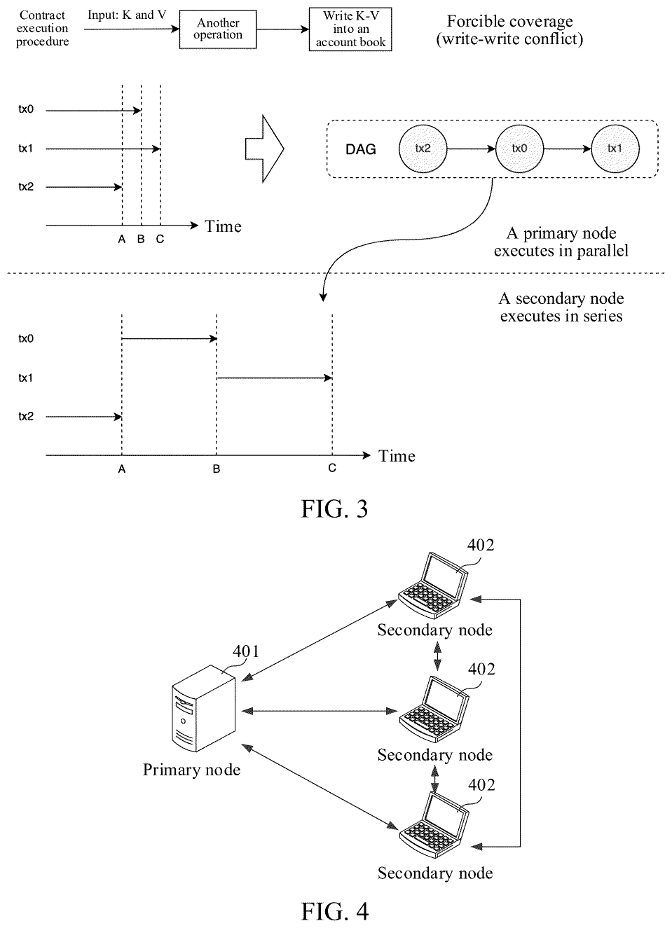

For ease of understanding, FIG. 3 is a schematic diagram of a transaction processing process of a primary node and a transaction processing process of a secondary node in the related art. As shown in FIG. 3, an execution procedure of an intelligent contract includes two parts. First, another operation (for example, an operation) is performed, and then an obtained execution result (corresponding to K-V) of a transaction is written into a transaction snapshot of the primary node. The operation of performing another operation is an operation of executing transactions in parallel/in series to obtain execution results of the transactions. The operation of writing the execution results into the transaction snapshot is an operation of writing the execution results of the transactions into the transaction snapshot in series after the execution of the transactions is completed to obtain the execution results of the transactions in the embodiments of the present disclosure.

For a write-write conflict, there is no process of querying K (which is distinguished from a read-write conflict below), namely, a case of forcible coverage.

### Primary Node Side:

When other operations are performed, the operations may be completely performed in parallel because for a write operation, an influence range during execution is only a current transaction execution period, and a write set generated by the write operation is updated to a transaction snapshot of the primary node after transaction execution is completed (when there is no conflict).

To be specific, the primary node executes three transactions: a transaction tx0, a transaction tx1, and a transaction tx2 in parallel, and the primary node updates a result of completing execution of a last transaction corresponding to K, for example, the transaction tx1 in FIG. 3 to the transaction snapshot of the primary node. FIG. 3 shows that execution of the transaction tx2 is completed at a moment A, execution of the transaction tx0 is completed at a moment B, and execution of the transaction tx1 is completed at a moment C. In other words, the execution of the transaction tx2 is first completed and an execution result is written into the transaction snapshot of the primary node, then the execution of the transaction tx0 is completed and an execution result is written into the transaction snapshot of the primary node (the execution result of the transaction tx2 is replaced), and finally the execution of the transaction tx1 is completed and an execution result is written into the transaction snapshot of the primary node (the execution result of the transaction tx0 is replaced).

After completing the execution of the three transactions: the transaction tx0, the transaction tx1, and the transaction tx2, the primary node generates a direct acyclic graph (DAG). The DAG is configured for indicating a secondary node to execute the three transactions: the transaction tx2, the transaction tx0, and the transaction tx1 in series in an order of tx2->tx0->tx1. In a process of generating the DAG, the primary node may consider that the three transactions: the transaction tx0, the transaction tx1, and the transaction tx2 conflict with each other. This is because the three transactions: the transaction tx0, the transaction tx1, and the transaction tx2 operate the same K, forming a write-write conflict. Therefore, the primary node constructs the DAG into a serial operation process: tx2->tx0->tx1.

### Secondary Node Side:

After receiving the DAG transmitted by the primary node, the secondary node performs operations based on the DAG, that is, executes the transaction tx2, the transaction tx0, and the transaction tx1 in series in the order of tx2->tx0->tx1, to obtain the execution result of the transaction tx2, the execution result of the transaction tx0, and the execution result of the transaction tx1; and then, writes the execution result of the transaction tx2 into a transaction snapshot of the secondary node, then writes the execution result of the transaction tx0 into the transaction snapshot of the secondary node, and finally writes the execution result of the transaction tx1 into the transaction snapshot of the secondary node. This leads to low transaction processing efficiency of the secondary node.

Therefore, to improve the transaction processing efficiency of the secondary node, the present disclosure provides a transaction processing solution. FIG. 4 is a schematic diagram of an implementation environment involved in the present disclosure. The implementation environment mainly includes a primary node 401 and a secondary node 402. The primary node 401 and the secondary node 402 are communicatively connected to each other by using a network. The network may include various connection types, such as a wireless communication link, a wired line, and an optical cable.

For example, the primary node 401 may be a server that provides various services, which includes but is not limited to an independent physical server, a server cluster or a distributed system including a plurality of physical servers, and a cloud server providing basic cloud computing services, such as a cloud service, a cloud database, cloud computing, a cloud function, cloud storage, a network service, cloud communication, a middleware service, a domain name service, a security service, a content delivery network, and a big data and artificial intelligence platform. The primary node 401 may be further a terminal device, which includes but is not limited to a smartphone, a tablet computer, a notebook computer, a computer, a smart speech interaction device, a smart home appliance, a smart wearable device, an aircraft, and the like.

For example, the secondary node 402 may be a server that provides various services, which includes but is not limited to an independent physical server, a server cluster or a distributed system including a plurality of physical servers, and a cloud server providing basic cloud computing services, such as a cloud service, a cloud database, cloud computing, a cloud function, cloud storage, a network service, cloud communication, a middleware service, a domain name service, a security service, a content delivery network, and a big data and artificial intelligence platform. The secondary node 402 may be further a terminal device, which includes but is not limited to a smartphone, a tablet computer, a notebook computer, a computer, a smart speech interaction device, a smart home appliance, a smart wearable device, an aircraft, and the like.

A quantity of primary nodes 401 and a quantity of secondary nodes 402 shown in FIG. 4 are merely used as examples. Any quantity of primary nodes 401 and any quantity of secondary nodes 402 may be deployed according to an actual requirement.

In an embodiment of the present disclosure, the transaction processing method may be performed by a primary node 401.

For example, the primary node generates execution information including transaction identification information, the execution information being configured to indicate that a plurality of transactions corresponding to the transaction identification information are to be executed in parallel by a secondary node; generates write information including a write order of execution results, the write information being configured to indicate that execution results of the plurality of transactions are to be sequentially written by the secondary node into a transaction snapshot of the secondary node according to the write order; and transmits the execution information and the write information to the secondary node.

In an embodiment of the present disclosure, the transaction processing method may be performed by a secondary node 402.

For example, the secondary node receives execution information including transaction identification information and write information including a write order of execution results that are transmitted by a primary node; then executes, in parallel, a plurality of transactions corresponding to the transaction identification information, to obtain execution results of the plurality of transactions; and then sequentially writes the execution results of the plurality of transactions into a transaction snapshot of the secondary node in the write order.

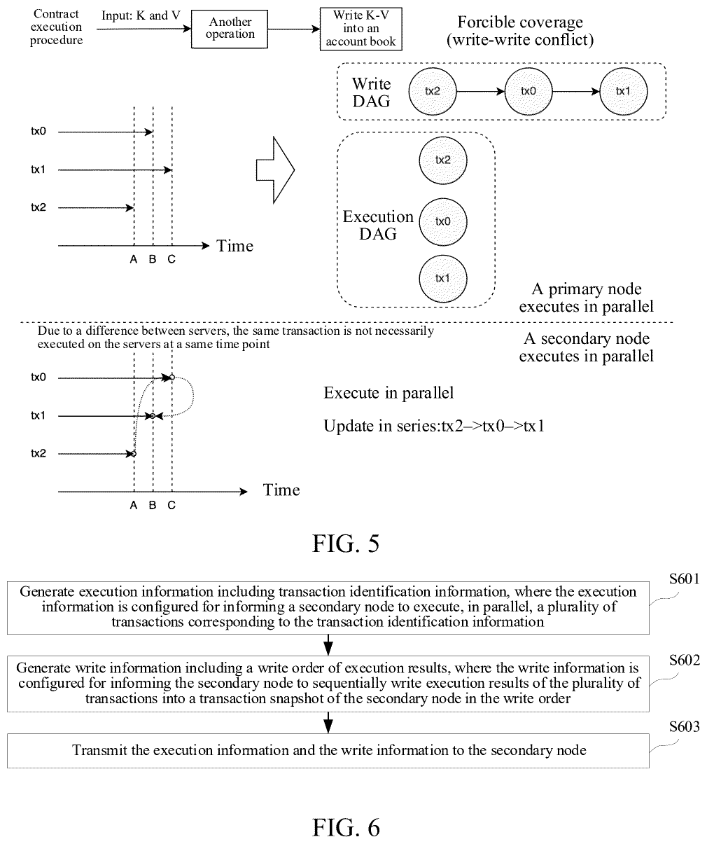

For ease of understanding, FIG. 5 is a schematic diagram of a transaction processing process of a primary node and a transaction processing process of a secondary node according to an embodiment of the present disclosure. Details are as shown in FIG. 5.

### Primary Node Side:

The primary node executes a transaction tx0, a transaction tx1, and a transaction tx2 in parallel; and then, the execution of the transaction tx2 is first completed and an execution result is written into a transaction snapshot of the primary node, then the execution of the transaction tx0 is completed and an execution result is written into the transaction snapshot of the primary node, and finally the execution of the transaction tx1 is completed and an execution result is written into the transaction snapshot of the primary node.

An execution DAG and a write DAG are generated. The execution DAG is configured for indicating the secondary node to execute the three transactions: the transaction tx0, the transaction tx1, and the transaction tx2 in parallel. The write DAG is configured for indicating the secondary node to first write the execution result of the transaction tx2 into the transaction snapshot of the secondary node, then write the execution result of the transaction tx0 into the transaction snapshot of the secondary node, and finally write the execution result of the transaction tx1 into the transaction snapshot of the secondary node in an order of tx2->tx0->tx1.

### Secondary Node Side:

The secondary node executes the transactions in parallel based on the foregoing execution DAG, that is, executes the transaction tx0, the transaction tx1, and the transaction tx2 in parallel; and then, writes the execution results of the transactions in series based on the foregoing write DAG, that is, first writes the execution result of the transaction tx2 into the transaction snapshot of the secondary node, then writes the execution result of the transaction tx0 into the transaction snapshot of the secondary node, and finally writes the execution result of the transaction tx1 into the transaction snapshot of the secondary node.

To reflect a difference between the secondary node and the primary node, an execution time point of the transaction tx0 and an execution time point of the transaction tx1 are specifically adjusted in FIG. 5. FIG. 5 shows that the execution of the transaction tx1 is completed earlier than the execution of the transaction tx0 on the secondary node. However, the execution results need to be written into the transaction snapshot of the secondary node based on the write DAG. That is, the execution result of the transaction tx0 is first written into the transaction snapshot of the secondary node, and then the execution result of the transaction tx1 is written into the transaction snapshot of the secondary node.

In this way, through implementation of the embodiments of the present disclosure, the primary node generates the execution DAG and the write DAG. The secondary node executes the transactions in parallel based on the execution DAG, to improve transaction processing efficiency of the secondary node. In addition, the secondary node writes the execution results of the transactions in series based on the write DAG, to ensure consistency between the execution results of the secondary node in the transaction snapshot and the execution results of the primary node in the transaction snapshot.

The technical solution of the embodiment shown in FIG. 4 may be applied to various scenarios, including but not limited to intelligent traffic, assisted driving, cloud technologies, artificial intelligence, and the like. During actual application, corresponding adjustment may be performed according to a specific application scenario.

In specific implementations of the present disclosure, data related to a user is involved. When the embodiments of the present disclosure are applied to specific products or technologies, user permission or consent needs to be obtained, and collection, use, and processing of related data need to comply with related laws, regulations, and standards of related countries and regions.

The implementation details of the technical solution of the embodiments of the present disclosure are described in detail below.

FIG. 6 is a flowchart of a transaction processing method according to an embodiment of the present disclosure. The transaction processing method may be performed by a computer device serving as a primary node 401. As shown in FIG. 6, the transaction processing method includes at least S601 to S603, which are described in detail below.

S601: Generate execution information including transaction identification information, where the execution information is configured to indicate that a plurality of transactions corresponding to the transaction identification information are to be executed in parallel by a secondary node.

In the embodiments of the present disclosure, the transaction identification information refers to identification information of a transaction. The identification information is configured for uniquely identifying the transaction, and includes, but is not limited to, a transaction number, a transaction name, transaction time, and the like.

In the embodiments of the present disclosure, the execution information includes the identification information of the plurality of transactions. The execution information is configured for indicating the secondary node to execute, in parallel, the plurality of transactions corresponding to the identification information of the plurality of transactions.

For example, the execution information includes identification information of three transactions: tx0, tx1, and tx2. In this case, the execution information is configured for indicating the secondary node to execute, in parallel, the transaction tx0, the transaction tx1, and the transaction tx2.

S602: Generate write information including a write order of execution results, where the write information is configured to indicate that execution results of the plurality of transactions are to be sequentially written by the secondary node into a transaction snapshot of the secondary node according to the write order.

The write order of the execution results in the embodiments of the present disclosure refers to an order in which the execution results of the plurality of transactions are written into the transaction snapshot. The write order of the execution results is an order in which the primary node writes the execution results of the plurality of transactions into the transaction snapshot of the primary node, and is also an order in which the secondary node writes the execution results of the plurality of transactions into the transaction snapshot of the secondary node. That is, an order in which the secondary node writes the execution results of the plurality of transactions into the transaction snapshot of the secondary node is the same as an order in which the primary node writes the execution results of the plurality of transactions into the transaction snapshot of the primary node. In this way, consistency between the execution results finally written by the secondary node into the transaction snapshot of the secondary node and the execution results finally written by the primary node into the transaction snapshot of the primary node is ensured.

The write information in the embodiments of the present disclosure includes the order in which the execution results of the plurality of transactions are written into the transaction snapshot of the secondary node. The write information is configured for indicating the secondary node to sequentially write the execution results of the plurality of transactions into the transaction snapshot of the secondary node in the order.

For example, following the foregoing example, assuming that the write information includes a write order of execution results of three transactions: tx2->tx0->tx1, the write information is configured for indicating the secondary node to first write the execution result of the transaction tx2 into the transaction snapshot of the secondary node, then write the execution result of the transaction tx0 into the transaction snapshot of the secondary node, and finally write the execution result of the transaction tx1 into the transaction snapshot of the secondary node in the order of tx2->tx0->tx1.

In the embodiments of the present disclosure, the transaction snapshot refers to a local account book of a node. The transaction snapshot of the primary node refers to a local account book of the primary node, and the transaction snapshot of the secondary node refers to a local account book of the secondary node, which are configured for storing the execution results of the transactions.

In the embodiments of the present disclosure, S601 and S602 may be performed in parallel, or may be performed in any exchange order. During actual application, S601 and S602 may be flexibly adjusted according to a specific application scenario.

S603: Transmit the execution information and the write information to the secondary node.

In the embodiments of the present disclosure, the primary node generates the execution information and the write information, and then may transmit the execution information and the write information to the secondary node. Correspondingly, the secondary node receives the execution information and the write information that are transmitted by the primary node, then performs, in parallel based on the transaction identification information included in the execution information, the plurality of transactions corresponding to the transaction identification information, to obtain the execution results of the plurality of transactions, and then sequentially writes the execution results of the plurality of transactions into the transaction snapshot of the secondary node in the write order included in the write information.

In the embodiments of the present disclosure, the primary node generates the execution information including the transaction identification information and the write information including the write order of the execution results, and transmits the execution information and the write information to the secondary node. Further, the secondary node may execute, in parallel, the plurality of transactions corresponding to the transaction identification information in the execution information, to obtain the execution results corresponding to the plurality of transactions, thereby improving transaction processing efficiency of the secondary node. In addition, the secondary node sequentially writes the execution results of the plurality of transactions into the transaction snapshot of the secondary node in the write order of the execution results in the write information, to ensure consistency between the execution results of the secondary node in the transaction snapshot and the execution results of the primary node in the transaction snapshot.

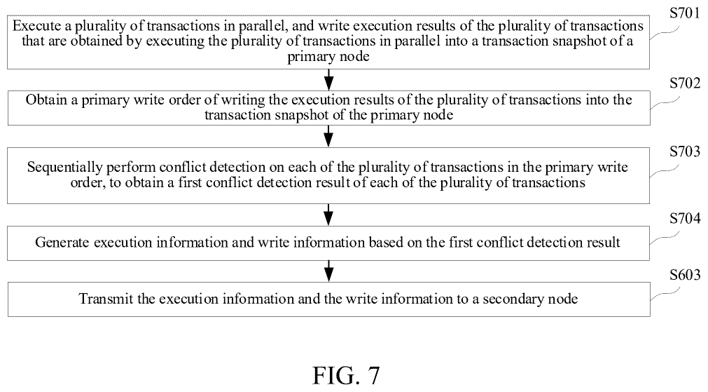

In an embodiment of the present disclosure, another transaction processing method is provided. The transaction processing method may be performed by a computer device serving as a primary node 401. As shown in FIG. 7, the transaction processing method may include S701 to S704, and S603.

S701 to S704 are described in detail below.

S701: Execute a plurality of transactions in parallel, and write execution results of the plurality of transactions that are obtained by executing the plurality of transactions in parallel into a transaction snapshot of a primary node.

In the embodiments of the present disclosure, the primary node may execute the plurality of transactions in parallel, and write the execution results of the plurality of transactions that are obtained by executing the plurality of transactions in parallel into the transaction snapshot of the primary node.

For example, assuming that to-be-executed transactions include a transaction tx0, a transaction tx1, and a transaction tx2, the primary node executes the transaction tx0, the transaction tx1, and the transaction tx2 in parallel, to obtain an execution result of the transaction tx0, an execution result of the transaction tx1, and an execution result of the transaction tx2. Then, in a transaction complete order, first, the execution result of the transaction tx2 is written into the transaction snapshot of the primary node, then, the execution result of the transaction tx0 is written into the transaction snapshot of the primary node, and finally, the execution result of the transaction tx1 is written into the transaction snapshot of the primary node.

S702: Obtain a write order of writing the execution results of the plurality of transactions into the transaction snapshot of the primary node. The write order of the primary node may also be referred as primary write order.

In the embodiments of the present disclosure, the primary node may write the execution results of the plurality of transactions obtained by executing the plurality of transactions in parallel into the transaction snapshot of the primary node, and then may obtain the primary write order of writing the execution results of the plurality of transactions into the transaction snapshot of the primary node.

For example, following the foregoing example, the primary node first writes the execution result of the transaction tx2 into the transaction snapshot of the primary node, then writes the execution result of the transaction tx0 into the transaction snapshot of the primary node, and finally writes the execution result of the transaction tx1 into the transaction snapshot of the primary node. Therefore, a primary write order that is obtained by the primary node and in which the execution results of the transaction tx0, the transaction tx1, and the transaction tx2 are respectively written into the transaction snapshot of the primary node is tx2->tx0->tx1.

S703: Sequentially perform conflict detection on each of the plurality of transactions in the primary write order, to obtain a first conflict detection result of each of the plurality of transactions.

In the embodiments of the present disclosure, the primary node obtains the primary write order of writing the execution results of the plurality of transactions into the transaction snapshot of the primary node, and then may sequentially perform conflict detection on each of the plurality of transactions in the primary write order, to obtain the first conflict detection result of each of the plurality of transactions.

In the embodiments of the present disclosure, the conflict detection refers to performing detection on whether there are conflicts about reading and writing between the transactions. The conflicts include a write-write conflict, a read-write conflict, and a write-read conflict.

In the embodiments of the present disclosure, the first conflict detection result is a conflict detection result of each transaction that is obtained by performing conflict detection on each transaction at a stage at which the primary node generates the execution information and the write information.

For example, following the foregoing example, because an order of writing the execution results of the transaction tx0, the transaction tx1, and the transaction tx2 into the transaction snapshot of the primary node is tx2->tx0->tx1, the primary node first performs conflict detection on the transaction tx2, to obtain a first conflict detection result Cₜₓ₂ of the transaction tx2, then, performs conflict detection on the transaction tx0, to obtain a first conflict detection result Cₜₓ₀ of the transaction tx0, and finally, performs conflict detection on the transaction tx1, to obtain a first conflict detection result Cₜₓ₁ of the transaction tx1.

S704: Generate the execution information and the write information based on the first conflict detection result.

In the embodiments of the present disclosure, the primary node obtains the first conflict detection result of each transaction, and then may generate the execution information and the write information based on the first conflict detection result.

For example, following the foregoing example, the first conflict detection result Cₜₓ₂ of the transaction tx2, the first conflict detection result Cₜₓ₀ of the transaction tx0, and the first conflict detection result Cₜₓ₁ of the transaction tx1 are obtained. The execution information and the write information may be generated based on the first conflict detection result Cₜₓ₂ of the transaction tx2, the first conflict detection result Cₜₓ₀ of the transaction tx0, and the first conflict detection result Cₜₓ₁ of the transaction tx1.

For detailed descriptions of S603 shown in FIG. 7, refer to S603 shown in FIG. 6, and details are not described herein again.

In the embodiments of the present disclosure, the primary node executes the plurality of transactions in parallel, writes, into the transaction snapshot of the primary node, the execution results of the plurality of transactions obtained by executing the plurality of transactions in parallel, then performs conflict detection on each transaction, and generates the execution information and the write information based on the first conflict detection result of each transaction, to improve accuracy of the execution information and the write information that are generated by the primary node, and provide strong support for the secondary node to execute the plurality of transactions in parallel based on the execution information, and write the execution results of the plurality of transactions into the transaction snapshot of the secondary node based on the write information.

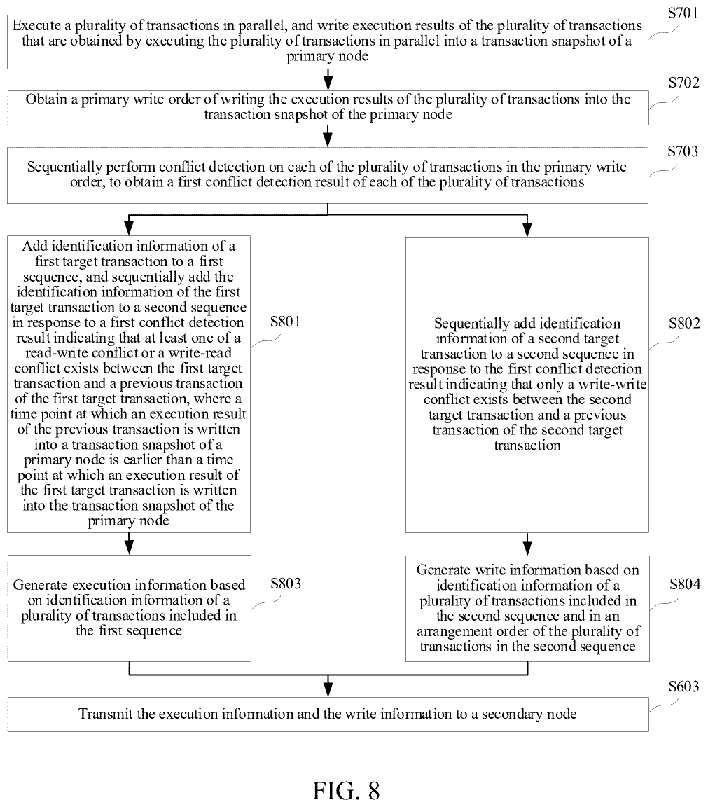

In an embodiment of the present disclosure, another transaction processing method is provided. The transaction processing method may be performed by a computer device serving as a primary node 401. As shown in FIG. 8, the transaction processing method may include S701 to S703, S801 to S804, and S603.

Any transaction in the embodiments of the present disclosure refers to each of a plurality of transactions in the foregoing embodiments and may also be referred as a target transaction.

For example, following the foregoing example, it is assumed that there are three transactions: a transaction tx0, a transaction tx1, and a transaction tx2, where any one of the transactions is the transaction tx0, the transaction tx1, or the transaction tx2.

In the embodiments of the present disclosure, a previous transaction of any transaction (i.e., a previous transaction of a target transaction) refers to a transaction corresponding to a time point at which the execution result is written into the transaction snapshot of the primary node that is earlier than a time point at which the execution result of any transaction (i.e., the target transaction) is written into the transaction snapshot of the primary node.

For example, assuming that execution results of i+n transactions are stored in the transaction snapshot of the primary node, and an i^{th} execution result of the transaction tx2 is written into the transaction snapshot of the primary node, time points at which execution results of transactions corresponding to [0, 1, 2, . . . , and i−1] are written into the transaction snapshot of the primary node are earlier than the time point at which the execution result of the transaction tx2 is written into the transaction snapshot of the primary node. In this case, at least one of transactions corresponding to [0, 1, 2, . . . , and i−1] is a previous transaction of the transaction tx2.

S801 to S804 are described in detail below.

S801: Add identification information of any transaction (e.g., a first target transaction) to a first sequence, and sequentially add the identification information of any transaction (e.g., the first target transaction) to a second sequence if a first conflict detection result represents that at least one of a read-write conflict or a write-read conflict exists between any transaction (e.g., the first target transaction) and a previous transaction (e.g., a previous transaction of the first target transaction), where a time point at which an execution result of the previous transaction is written into a transaction snapshot of a primary node is earlier than a time point at which an execution result of any transaction is written into the transaction snapshot of the primary node.

In the embodiments of the present disclosure, in response to the first conflict detection result indicating that at least one of the read-write conflict or the write-read conflict exists between any transaction and the previous transaction, the primary node may add the identification information of any transaction to the first sequence, and sequentially add the identification information of any transaction to the second sequence.

In the embodiments of the present disclosure, that at least one of the read-write conflict or the write-read conflict exists between any transaction and the previous transaction includes two cases:
case 1: No write-write conflict exists between any transaction and the previous transaction, but at least one of the read-write conflict or the write-read conflict exists between any transaction and the previous transaction; and
case 2: The write-write conflict exists between any transaction and the previous transaction, and at least one of the read-write conflict or the write-read conflict exists between any transaction and the previous transaction.

For example, following the foregoing example, Q1=[ ] is configured for representing the first sequence, and Q2=[ ] is configured for representing the second sequence.

Assuming that in a process in which conflict detection is performed on the transaction tx2, a case that a first conflict detection result Cₜₓ₂ of the transaction tx2 represents that at least one of the read-write conflict or the write-read conflict exists between the transaction tx2 and a previous transaction of the transaction tx2 is detected, the transaction tx2 is added to the first sequence Q1, that is, Q1=[tx2], and the transaction tx2 is added to the second sequence Q2, that is, Q2=[tx2].

Assuming that in a process in which conflict detection is performed on the transaction tx0, a case that a first conflict detection result Cₜₓ₀ of the transaction tx0 represents that at least one of the read-write conflict or the write-read conflict exists between the transaction tx0 and a previous transaction of the transaction tx0 is detected, the transaction tx0 is added to the first sequence Q1, that is, Q1=[tx2, tx0], and the transaction tx0 is added to the second sequence Q2, that is, Q2=[tx2->tx0].

Assuming that in a process in which conflict detection is performed on the transaction tx1, a case that a first conflict detection result Cₜₓ₁ of the transaction tx1 represents that at least one of the read-write conflict or the write-read conflict exists between the transaction tx1 and a previous transaction of the transaction tx1 is detected, the transaction tx1 is added to the first sequence Q1, that is, Q1=[tx2, tx0, tx1], and the transaction tx1 is added to the second sequence Q2, that is, Q2=[tx2->tx0->tx1].

The write-write conflict may occur in a plurality of scenarios.

For example, in a scenario of transferring virtual resources, a user 1 transfers a quantity a of virtual resources to a user 3, and a user 2 transfers a quantity b of virtual resources to the user 3. In this case, for the user 3, the quantity a of virtual resources transferred by the user 1 needs to be written, and the quantity b of virtual resources transferred by the user 2 also needs to be written. In this case, the write-write conflict exists.

For example, in a scenario of purchasing commodities, a user 1 orders a quantity a of commodities A, and a user 2 also orders a quantity b of commodities A. For a stock of the commodities A, the quantity a of commodities A ordered by the user 1 needs to be written, and the quantity b of commodities A ordered by the user 2 also needs to be written. In this case, the write-write conflict exists.

The read-write conflict may occur in a plurality of scenarios.

For example, in a scenario transferring virtual resources, a user 3 transfers a quantity c of virtual resources to a user 1, and a user 2 transfers a quantity b of virtual resources to the user 3. For the user 3, when transferring the quantity c of virtual resources to the user 1, a current quantity of virtual resources of the user 3 needs to be read, and the quantity b of virtual resources transferred by the user 2 also needs to be written. In this case, the read-write conflict exists.

For example, in a scenario of purchasing commodities, a user 1 cancels ordered commodities A of a quantity a, and a user 2 orders a quantity b of commodities A. In this case, for a stock of the commodities A, the user 1 cancels the ordered commodities A of the quantity a, the stock of the commodities A needs to be read, and the commodities A of the quantity b ordered by the user 2 also need to be written. In this case, the read-write conflict exists.

The write-read conflict may occur in a plurality of scenarios.

For example, in a scenario of transferring virtual resources, a user 2 transfers a quantity b of virtual resources to a user 3, and the user 3 transfers a quantity c of virtual resources to a user 1. In this case, for the user 3, the quantity b of virtual resources transferred by the user 2 needs to be written. In addition, because the user 3 transfers the quantity c of virtual resources to the user 1, the current quantity of virtual resources of the user 3 also needs to be read. In this case, the write-read conflict exists.

For example, in a scenario of purchasing commodities, a user 2 orders a quantity b of commodities A, and a user 1 cancels the ordered quantity a of commodities A. For a stock of the commodities A, the quantity b of commodities A ordered by the user 2 needs to be written, and because the user 1 cancels the ordered quantity a of commodities A, the stock of the commodities A also needs to be read. In this case, the write-read conflict exists.

The commodities involved in the foregoing scenario of purchasing commodities may be a ticket, an admission ticket, an object (such as clothes, headwear, an appliance, or food). In addition, during actual application, scenarios to which the write-write conflict, the read-write conflict, and the write-read conflict are applied may be adaptively adjusted according to specific conditions, and are not limited to the illustrated scenarios.

S802: Sequentially add the identification information of any transaction (e.g., a second target transaction) to the second sequence in response to the first conflict detection result indicating that only a write-write conflict exists between any transaction (e.g., the second target transaction) and a previous transaction (e.g., the previous transaction of the second target transaction.

In the embodiments of the present disclosure, in response to the first conflict detection result indicating that only the write-write conflict exists between any transaction and the previous transaction, the primary node may sequentially add the identification information of any transaction to the second sequence.

For example, following the foregoing example, Q2=[ ] is configured for representing the second sequence.

Assuming that in a process in which conflict detection is performed on the transaction tx2, a case that a first conflict detection result Cₜₓ₂ of the transaction tx2 represents that only the write-write conflict exists between the transaction tx2 and a previous transaction of the transaction tx2 is detected, the transaction tx2 is added to the second sequence Q2, that is, Q2=[tx2].

Assuming that in a process in which conflict detection is performed on the transaction tx0, a case that a first conflict detection result Cₜₓ₀ of the transaction tx0 represents that only the write-write conflict exists between the transaction tx0 and a previous transaction of the transaction tx0 is detected, the transaction tx0 is added to the second sequence Q2, that is, Q2=[tx2->tx0].

Assuming that in a process in which conflict detection is performed on the transaction tx1, a case that a first conflict detection result Cₜₓ₁ of the transaction tx1 represents that only the write-write conflict exists between the transaction tx1 and a previous transaction of the transaction tx1 is detected, the transaction tx1 is added to the second sequence Q2, that is, Q2=[tx2->tx0->tx1].

S803: Generate execution information based on identification information of a plurality of transactions included in the first sequence.

In the embodiments of the present disclosure, after completing conflict detection on the plurality of transactions, the primary node may generate the execution information based on the identification information of the plurality of transactions (e.g., the first target transactions) included in the first sequence.

For example, following the foregoing example, if the first sequence Q1=[tx2, tx0, tx1], execution information: tx2, tx0, and tx1 may be generated.

S804: Generate write information based on identification information of a plurality of transactions (e.g., the first and second target transactions) included in the second sequence and in an arrangement order of the plurality of transactions in the second sequence.

In the embodiments of the present disclosure, after completing conflict detection on the plurality of transactions, the primary node may generate the write information based on the identification information of the plurality of transactions included in the second sequence and in the arrangement order of the plurality of transactions.

For example, following the foregoing example, if the second sequence Q2=[tx2->tx0->tx1], the write information tx2->tx0->tx1 may be generated.

For detailed descriptions of S701 to S703 shown in FIG. 8, refer to S701 to S703 shown in FIG. 7. For detailed descriptions of S603 shown in FIG. 8, refer to S603 shown in FIG. 6. Details are not described herein again.

In the embodiments of the present disclosure, the primary node adaptively adds the identification information of each transaction to the first sequence and the second sequence based on the first conflict detection result of each transaction. In this way, the execution information and the write information are rapidly and accurately generated.

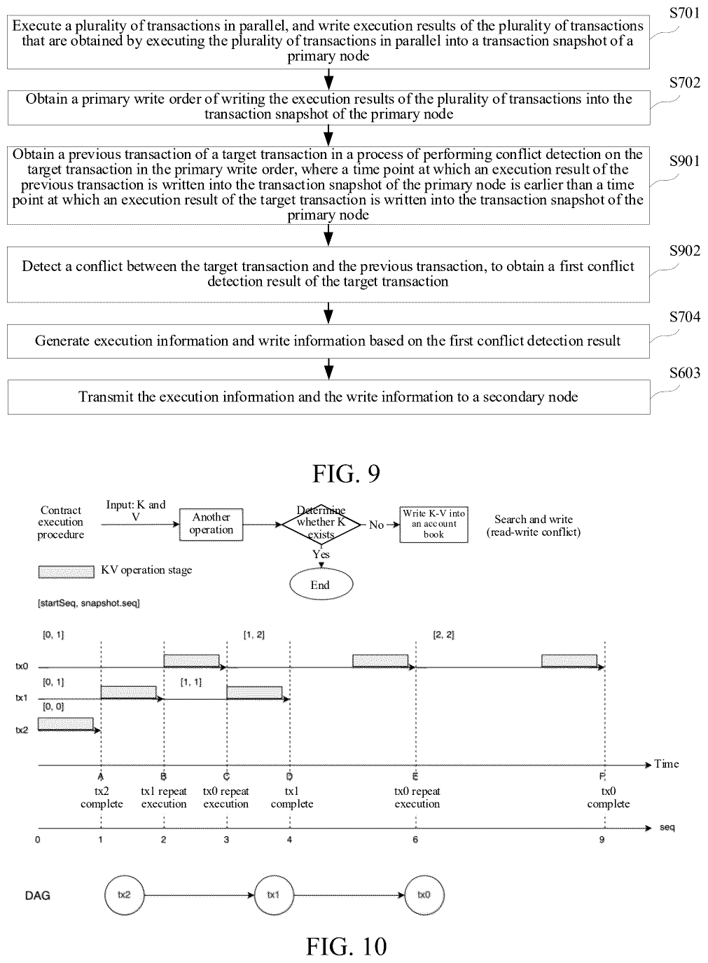

In an embodiment of the present disclosure, another transaction processing method is provided. The transaction processing method may be performed by a computer device serving as a primary node 401. As shown in FIG. 9, the transaction processing method may include S701 and S702, S901 and S902, S704, and S603.

In the embodiments of the present disclosure, a previous transaction of any transaction refers to a transaction corresponding to a time point at which the execution result is written into the transaction snapshot of the primary node that is earlier than a time point at which the execution result of any transaction is written into the transaction snapshot of the primary node.

For example, assuming that the transaction snapshot of the primary node stores execution results of i+n transactions, and an i^{th} execution result of the transaction tx2 is written into the transaction snapshot of the primary node, time points at which execution results of transactions respectively corresponding to [0, 1, 2, . . . , i−1] are written into the transaction snapshot of the primary node are earlier than the time point at which the execution result of the transaction tx2 is written into the transaction snapshot of the primary node. In this case, at least one of transactions corresponding to [0, 1, 2, . . . , i−1] is a previous transaction.

S901 and S902 are described in detail below.

S901: Obtain a previous transaction of any transaction (e.g. a target transaction) in a process of performing conflict detection on any transaction (e.g. the target transaction) in a write order, where a time point at which an execution result of the previous transaction is written into a transaction snapshot of a primary node is earlier than a time point at which an execution result of any transaction (e.g. the target transaction) is written into the transaction snapshot of the primary node.

In the embodiments of the present disclosure, in a process in which conflict detection is performed on any transaction in the write order, the primary node needs to obtain the previous transaction of any transaction.

For example, following the foregoing example, an execution result of a transaction tx2 is an i^{th} execution result that is written into the transaction snapshot of the primary node. In a process in which conflict detection is performed on the transaction tx2, a previous transaction of the transaction tx2 is first obtained. The previous transaction of the transaction tx2 may be at least one of transactions corresponding to [0, 1, 2, . . . , i−1].

It is assumed that an execution result of a transaction tx0 is an i+1^{th} execution result that is written into the transaction snapshot of the primary node. In a process in which conflict detection is performed on the transaction tx0, a previous transaction of the transaction tx0 is first obtained. The previous transaction of the transaction tx0 may be at least one of transactions corresponding to [0, 1, 2, . . . , i−1, i].

It is assumed that an execution result of a transaction tx1 is an i+2^{th} execution result that is written into the transaction snapshot of the primary node. In a process in which conflict detection is performed on the transaction tx1, a previous transaction of the transaction tx1 is first obtained. The previous transaction of the transaction tx1 may be at least one of transactions corresponding to [0, 1, 2, . . . , i−1, i, i+1].

A quantity of previous transactions of any transaction may be flexibly adjusted according to a specific application scenario.

S902: Detect a conflict between any transaction and the previous transaction, to obtain a first conflict detection result of any transaction (e.g. the target transaction).

In the embodiments of the present disclosure, the primary node obtains the previous transaction of any transaction, and then may detect the conflict between any transaction and the previous transaction, to obtain the first conflict detection result of any transaction.

In an embodiment of the present disclosure, the process of detecting the conflict between any transaction and the previous transaction, to obtain the first conflict detection result of any transaction in S902 may include:
obtaining a read-write set of any transaction and a read-write set of the previous transaction; and
detecting the conflict between any transaction and the previous transaction based on the read-write set of any transaction and the read-write set of the previous transaction, to obtain the first conflict detection result of any transaction.

To be specific, in one embodiment, the primary node implements conflict detection between any transaction and the previous transaction through the read-write set of any transaction and the read-write set of the previous transaction of any transaction.

For example, following the foregoing example, in a process in which conflict detection is performed on the transaction tx2, specifically, a conflict is detected between the transaction tx2 and the previous transaction of the transaction tx2 based on a read-write set of the transaction tx2 and a read-write set of the previous transaction of the transaction tx2, to obtain a first conflict detection result Cₜₓ₂ of the transaction tx2.

In a process in which conflict detection is performed on the transaction tx0, specifically, a conflict is detected between the transaction tx0 and the previous transaction of the transaction tx0 based on a read-write set of the transaction tx0 and a read-write set of the previous transaction of the transaction tx0, to obtain a first conflict detection result Cₜₓ₀ of the transaction tx0.

In a process in which conflict detection is performed on the transaction tx1, specifically, a conflict is detected between the transaction tx1 and the previous transaction of the transaction tx1 based on a read-write set of the transaction tx1 and a read-write set of the previous transaction of the transaction tx1, to obtain a first conflict detection result Cₜₓ₁ of the transaction tx1.

In an embodiment of the present disclosure, a quantity of previous transactions of any transaction is more than one.

For example, following the foregoing example, the previous transaction of the transaction tx2 may be a transaction corresponding to [i−2, i−1], the previous transaction of the transaction tx0 may be a transaction corresponding to [i−2, i−1, i], and the previous transaction of the transaction tx1 may be a transaction corresponding to [i−2, i−1, i, i+1].

In an embodiment of the present disclosure, if a quantity of previous transactions of any transaction is more than one, a process of obtaining the read-write set of any transaction and the read-write set of the previous transaction may include:
obtaining the read-write set of any transaction and the read-write sets of the plurality of previous transactions.

To be specific, in one embodiment, if a quantity of previous transactions of any transaction is more than one, when obtaining a read-write set of the previous transaction of any transaction, the primary node needs to obtain a read-write set corresponding to each previous transaction.

For example, following the foregoing example, in a process in which conflict detection is performed on the transaction tx2, assuming that a transaction corresponding to an (i−2)th execution result written into the transaction snapshot of the primary node is a transaction tx10, and a transaction corresponding to an (i−1)th execution result written into the transaction snapshot of the primary node is a transaction tx11, the read-write set of the transaction tx2, a read-write set of a transaction tx10, and a read-write set of a transaction tx11 are obtained.

In a process in which conflict detection is performed on the transaction tx0, the read-write set of the transaction tx0, the read-write set of the transaction tx2, the read-write set of the transaction tx10, and the read-write set of the transaction tx11 are obtained.

In a process in which conflict detection is performed on the transaction tx1, the read-write set of the transaction tx1, the read-write set of the transaction tx0, the read-write set of the transaction tx2, the read-write set of the transaction tx10, and the read-write set of the transaction tx11 are obtained.

Correspondingly, a process of detecting the conflict between any transaction and the previous transaction based on the read-write set of any transaction and the read-write set of the previous transaction, to obtain the first conflict detection result of any transaction may include:
detecting conflicts between any transaction and the plurality of previous transactions based on the read-write set of any transaction and the read-write sets of the plurality of previous transactions, to obtain a plurality of first conflict detection results of any transaction.

To be specific, in one embodiment, if a quantity of previous transactions of any transaction is more than one, the primary node obtains the read-write set of any transaction and the read-write sets of the plurality of previous transactions, and then detects the conflict between any transaction and each previous transaction based on the read-write set of any transaction and the read-write set of each previous transaction, to obtain the plurality of first conflict detection results of any transaction.

For example, following the foregoing example, in a process in which conflict detection is performed on the transaction tx2, a conflict between the read-write set of the transaction tx2 and the read-write set of the transaction tx10 is detected, and a conflict between the read-write set of the transaction tx2 and the read-write set of the transaction tx11 is detected, to obtain two first conflict detection results Cₜₓ₂ of the transaction tx2.

In a process in which conflict detection is performed on the transaction tx0, a conflict between the read-write set of the transaction tx0 and the read-write set of the transaction tx2 is detected, a conflict between the read-write set of the transaction tx0 and the read-write set of the transaction tx10 is detected, and a conflict between the read-write set of the transaction tx0 and the read-write set of the transaction tx11 is detected, to obtain three first conflict detection results Cₜₓ₀ of the transaction tx0.

In a process in which conflict detection is performed on the transaction tx1, a conflict between the read-write set of the transaction tx1 and the read-write set of the transaction tx0 is detected, a conflict between the read-write set of the transaction tx1 and the read-write set of the transaction tx2 is detected, a conflict between the read-write set of the transaction tx1 and the read-write set of the transaction tx10 is detected, and a conflict between the read-write set of the transaction tx1 and the read-write set of the transaction tx11 is detected, to obtain four first conflict detection results Cₜₓ₁ of the transaction tx1.

For detailed descriptions of S701 and S702 and S704 shown in FIG. 9, refer to S701 and S702 and S704 shown in FIG. 7. For detailed descriptions of S603 shown in FIG. 9, refer to S603 shown in FIG. 6. Details are not described herein again.

In the embodiments of the present disclosure, in a process of performing conflict detection on transactions in a write order, the primary node obtains previous transactions of the transactions, and then detects conflicts between the transactions and the previous transactions, to obtain first conflict detection results of the transactions. In this way, conflict detection on the plurality of transactions is implemented quickly and accurately.

When the plurality of transactions involve the read-write conflict, the primary node usually repeatedly executes the transaction. This causes a waste of resources of the primary node.

For ease of understanding, FIG. 10 is a schematic diagram of repeatedly executing a transaction by a primary node in the related art. As shown in FIG. 10,
a transaction tx0, a transaction tx1, and a transaction tx2 execute the same intelligent contract. An execution procedure of the intelligent contract includes two parts. First, another operation (for example, an operation) is performed, then whether an input K exists is determined, and if the input K exists, the procedure is ended, or if the input K does not exist, an obtained execution result (corresponding to K-V) of the transaction is written into a transaction snapshot of the primary node.

A read-write conflict occurs in the procedure because there is both a read operation and a write operation.

For example, it is assumed that there are the following scenarios.

(1) Another operation of the transaction tx0 takes 2 s, and a KV operation takes 1 s.

(2) Another operation of the transaction tx1 takes 1 s, and the KV operation takes 1 s.

(3) Another operation of the transaction tx2 takes 0 s, and the KV operation takes 1 s.

Assuming that the three transactions are in a same block, to accelerate, the primary node executes the three transactions in parallel, and the following cases occur.

(1) At a moment A (or a moment 1), execution of the transaction tx2 is completed, and an execution result of the transaction tx2 is written into the transaction snapshot of the primary node. In this case, writing succeeds because there is no conflict.

(2) At a moment B (or a moment 2), execution of the transaction tx1 is completed, but in this case, a case that there is a conflict between the transaction tx1 and the transaction tx2 is detected, and the transaction tx1 needs to be re-executed. There are the following two main reasons.

(A) When execution of the transaction tx1 and the transaction tx2 starts, quantities of execution results of transactions that have been written into the transaction snapshot of the primary node are the same (as shown in FIG. 10, transaction snapshot states starSeq that are obtained when execution of the transaction tx1 and the transaction tx2 starts are 0), but when writing of the transaction tx1 is completed, it is found that the transaction snapshot state changes (as shown in FIG. 10, a transaction snapshot state snapshot.seq that is obtained when writing of the transaction tx1 is completed is 1), which indicates that writing is completed in transaction execution during execution of the transaction tx1 (there is no conflict when no writing is not performed, but there is not necessarily a conflict when writing is performed). In this case, conflict detection on a read-write set is performed.

(B) During conflict detection, because there is a read-write conflict between the transaction tx1 and the transaction tx2 whose execution has been completed (in this case, the read-write set of the transaction tx2 has been written into the transaction snapshot of the primary node), it is determined that the transaction tx1 needs to be re-executed.

(3) At a moment C (or a moment 3), execution of the transaction tx0 is completed. Similarly, in this case, a case that there is a conflict between the transaction tx0 and the transaction tx2 is detected, and the transaction tx0 needs to be re-executed. A main reason is the same as above, and details are not described herein again.

(4) At a moment D (or a moment 4), re-execution of the transaction tx1 is completed. In this case, because a transaction snapshot state at which the transaction tx1 starts is consistent with a transaction snapshot state at which writing is completed (as shown in FIG. 10, a transaction snapshot state starSeq at which re-execution of the transaction tx1 starts is 1, and a transaction snapshot state snapshot.seq at which re-writing of the transaction tx1 is completed is 1), which indicates that no writing is completed in transaction execution during re-execution of the transaction tx1, and the execution result of the transaction tx1 is written into the transaction snapshot of the primary node.

(5) At a moment E (or a moment 6), re-execution of the transaction tx0 is completed. Similarly, in this case, a case that there is a conflict between the transaction tx0 and the transaction tx1 is detected. There is a conflict between the transaction tx0 and the transaction tx1. In this way, because a transaction snapshot state at which re-execution of the transaction tx0 starts already includes the execution result of the transaction tx2, and the execution result of the transaction tx1 is written into the transaction snapshot of the primary node in the process of re-executing the transaction tx0, the transaction tx0 is re-executed.

(6) At a moment P (or a moment 9), re-execution of the transaction tx0 is completed.

It can be learned that, the transaction tx1 is repeatedly executed once, and the transaction tx0 is repeatedly executed twice. Actually, operations having an impact on the read-write conflict are performed within a last is, and other operations do not have an impact on the conflict. Therefore, although the three transactions actually conflict with each other, the transaction tx0 and the transaction tx1 do not need to be repeatedly executed.

Therefore, to reduce repeated execution of transactions performed by the primary node, and avoid a waste of resources of the primary node, in the embodiments of the present disclosure, in a process of writing an execution result of any transaction into the transaction snapshot of the primary node (namely, the KV operation stage), the primary node may detect a quantity change of the execution results that have been written into the transaction snapshot of the primary node, to further determine, based on a detection result, whether to re-execute a transaction.

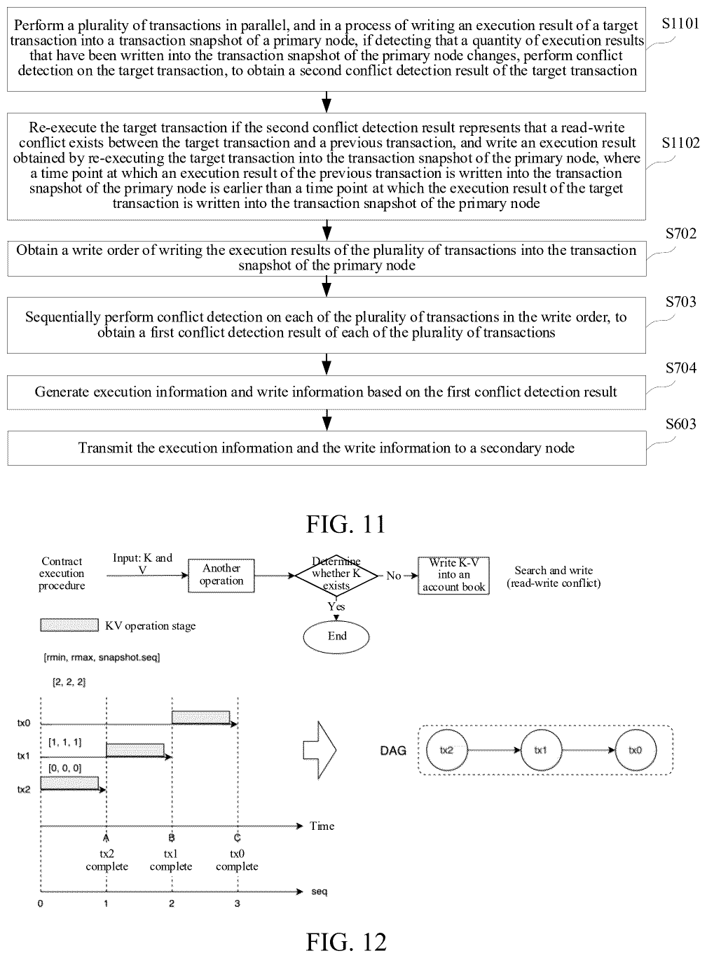

In an embodiment of the present disclosure, another transaction processing method is provided. The transaction processing method may be performed by a computer device serving as a primary node 401. As shown in FIG. 11, the transaction processing method may include S1101 and S1102, S702 to S704, and S603.

S1101 and S1102 are described in detail below.

S1101: In a process of writing an execution result of any transaction (e.g. a target transaction) into a transaction snapshot of a primary node, if detecting that a quantity of execution results that have been written into the transaction snapshot of the primary node changes, perform conflict detection on any transaction, to obtain a second conflict detection result of any transaction (e.g. the target transaction).

In the embodiments of the present disclosure, in a process in which the execution result of any transaction is written into the transaction snapshot of the primary node, if detecting that the quantity of execution results that have been written into the transaction snapshot of the primary node changes, the primary node performs conflict detection on any transaction, to obtain the second conflict detection result of any transaction.

Any transaction in the embodiments of the present disclosure refers to each of a plurality of transactions in the foregoing embodiments.

For example, it is assumed that there are three transactions: a transaction tx0, a transaction tx1, and a transaction tx2, where any one of the transactions is the transaction tx0, the transaction tx1, or the transaction tx2.

In the embodiments of the present disclosure, the second conflict detection result is a conflict detection result of each transaction that is obtained by performing conflict detection on each transaction at a stage at which the primary node writes the execution result of each transaction into the transaction snapshot of the primary node.

For example, following the foregoing example, in a process in which the execution result of the transaction tx2 is written into the transaction snapshot of the primary node, if a case that the quantity of execution results that have been written into the transaction snapshot of the primary node changes is detected, conflict detection is performed on the transaction tx2, to obtain a second conflict detection result of the transaction tx2.

In a process in which an execution result of a transaction tx0 is written into the transaction snapshot of the primary node, if a case that the quantity of execution results that have been written into the transaction snapshot of the primary node changes is detected, conflict detection is performed on the transaction tx0, to obtain a second conflict detection result of the transaction tx0.

In a process in which an execution result of a transaction tx1 is written into the transaction snapshot of the primary node, if a case that the quantity of execution results that have been written into the transaction snapshot of the primary node changes is detected, conflict detection is performed on the transaction tx1, to obtain a second conflict detection result of the transaction tx1.

S1102: Re-execute any transaction (e.g. the target transaction) if the second conflict detection result represents that the read-write conflict exists between any transaction (e.g. the target transaction) and the previous transaction, and write an execution result obtained by re-executing any transaction (e.g. the target transaction) into the transaction snapshot of the primary node, where a time point at which an execution result of the previous transaction is written into the transaction snapshot of the primary node is earlier than a time point at which the execution result of any transaction (e.g. the target transaction) is written into the transaction snapshot of the primary node.

In the embodiments of the present disclosure, if the second conflict detection result represents that the read-write conflict exists between any transaction and the previous transaction, any transaction is re-executed, and an execution result obtained by re-executing any transaction is written into the transaction snapshot of the primary node.

In the embodiments of the present disclosure, if the second conflict detection result represents that no read-write conflict exists between any transaction and the previous transaction, any transaction does not need to be re-executed.

For the previous transaction in the embodiments of the present disclosure, refer to descriptions in the foregoing embodiments. Details are not described herein again.

For ease of understanding, FIG. 12 is a schematic diagram of a transaction processing process of a primary node according to an embodiment of the present disclosure. As shown in FIG. 12,
if the primary node executes the three transactions in parallel, the following cases occur.

(1) At a moment A (or a moment 1), execution of the transaction tx2 is completed, and an execution result of the transaction tx2 is written into the transaction snapshot of the primary node. In this case, writing succeeds because there is no conflict.

(2) At a moment B (or a moment 2), execution of the transaction tx1 is completed, and the execution result of the transaction tx1 is written into the transaction snapshot of the primary node. In this case, writing succeeds because in a process in which the execution result of the transaction tx1 is written into the transaction snapshot of the primary node (namely, a KV operation stage of the transaction tx1), a quantity of execution results that have been written into the transaction snapshot of the primary node does not change, and a case that there is no conflict is detected.

(3) At a moment C (or a moment 3), execution of the transaction tx0 is completed, and the execution result of the transaction tx0 is written into the transaction snapshot of the primary node. In this case, writing succeeds because in a process in which the execution result of the transaction tx0 is written into the transaction snapshot of the primary node (namely, a KV operation stage of the transaction tx0), a quantity of execution results that have been written into the transaction snapshot of the primary node does not change, and a case that there is no conflict is detected.

It can be learned that, the primary node does not need to repeatedly execute the transaction tx0 and the transaction tx1.

In this way, through implementation of the embodiments of the present disclosure, the primary node reduces repeated execution of transactions of the primary node, to avoid a waste of resources of the primary node.

For detailed descriptions of S702 to S704 shown in FIG. 11, refer to S702 to S704 shown in FIG. 7. For detailed descriptions of S603 shown in FIG. 11, refer to S603 shown in FIG. 6. Details are not described herein again.

S1101 and S1102 shown in FIG. 11 may be independently performed without S702 to S704 and S603.

In the embodiments of the present disclosure, in a process of writing the execution result of the transaction into the transaction snapshot of the primary node (namely, the KV operation stage), the primary node detects a quantity change of the execution results that have been written into the transaction snapshot of the primary node, and then determines, based on the detection result, whether the transaction needs to be re-executed, thereby greatly reducing repeated execution of transactions of the primary node, avoiding a waste of resources of the primary node, and improving transaction processing efficiency of the primary node.

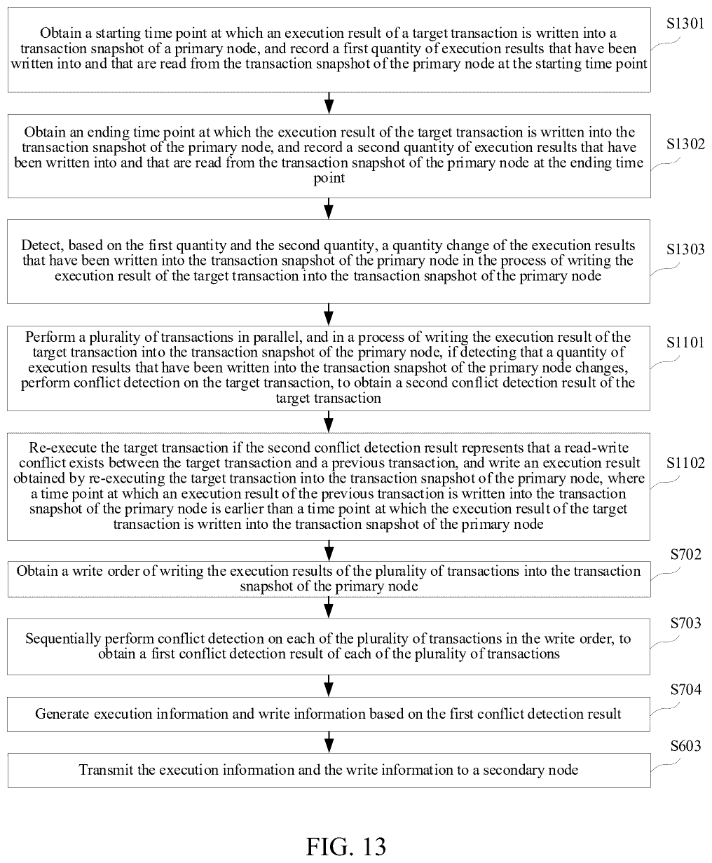

In an embodiment of the present disclosure, another transaction processing method is provided. The transaction processing method may be performed by a computer device serving as a primary node 401. As shown in FIG. 13, the transaction processing method may further include S1301 to S1303 before S1101.

S1301 to S1303 are described in detail below.

S1301: Obtain a starting time point at which an execution result of any transaction is written into a transaction snapshot of a primary node, and record a first quantity of execution results that have been written into and that are read from the transaction snapshot of the primary node at the starting time point.

In the embodiments of the present disclosure, the primary node obtains the starting time point at which the execution result of any transaction is written into the transaction snapshot of the primary node, and records the first quantity of execution results that have been written into and that are read from the transaction snapshot of the primary node at the starting time point.

In the embodiments of the present disclosure, the starting time point at which the execution result of any transaction is written into the transaction snapshot of the primary node is a starting time point of a KV operation stage.

In the embodiments of the present disclosure, the first quantity refers to a quantity of execution results that have been written into and that are read from the transaction snapshot of the primary node at the starting time point.

For example, following the foregoing example, still refer to FIG. 12. For a transaction tx2, the starting time point at which an execution result of the transaction tx2 is written into the transaction snapshot of the primary node is a moment 0, and the first quantity rmin of execution results that have been written into and that are read from the transaction snapshot of the primary node at the moment 0 is recorded as 0.

For a transaction tx1, the starting time point at which an execution result of the transaction tx1 is written into the transaction snapshot of the primary node is a moment A (or a moment 1), and the first quantity rmin of execution results that have been written into and that are read from the transaction snapshot of the primary node at the moment A is recorded as 1.

For a transaction tx0, the starting time point at which the execution result of the transaction tx0 is written into the transaction snapshot of the primary node is a moment B (or a moment 2), and the first quantity rmin of execution results that have been written into and that are read from the transaction snapshot of the primary node at the moment B is recorded as 2.

S1302: Obtain an ending time point at which the execution result of any transaction is written into the transaction snapshot of the primary node, and record a second quantity of execution results that have been written into and that are read from the transaction snapshot of the primary node at the ending time point.

In the embodiments of the present disclosure, the primary node further obtains the ending time point at which the execution result of any transaction is written into the transaction snapshot of the primary node, and records the second quantity of execution results that have been written into and that are read from the transaction snapshot of the primary node at the ending time point.

In the embodiments of the present disclosure, the ending time point at which the execution result of any transaction is written into the transaction snapshot of the primary node is an ending time point of the KV operation stage.

In the embodiments of the present disclosure, the second quantity refers to a quantity of execution results that have been written into and that are read from the transaction snapshot of the primary node at the ending time point.

For example, following the foregoing example, still refer to FIG. 12. For the transaction tx2, the ending time point at which the execution result of the transaction tx2 is written into the transaction snapshot of the primary node is a moment A (or a moment 1), and a second quantity snapshot.seq of execution results that have been written into and that are read from the transaction snapshot of the primary node at the moment A is recorded as 0.

For the transaction tx1, the ending time point at which the execution result of the transaction tx1 is written into the transaction snapshot of the primary node is a moment B (or a moment 2), and the second quantity snapshot.seq of execution results that have been written into and that are read from the transaction snapshot of the primary node at the moment B is recorded as 1.

For the transaction tx0, the ending time point at which the execution result of the transaction tx0 is written into the transaction snapshot of the primary node is a moment C (or a moment 3), and the second quantity snapshot.seq of execution results that have been written into and that are read from the transaction snapshot of the primary node at the moment C is recorded as 2.

S1303: Detect, based on the first quantity and the second quantity, a quantity change of the execution results that have been written into the transaction snapshot of the primary node in the process of writing the execution result of any transaction into the transaction snapshot of the primary node.

In the embodiments of the present disclosure, the primary node obtains the first quantity and the second quantity, and then may detect, based on the first quantity and the second quantity, the quantity change of the execution results that have been written into the transaction snapshot of the primary node in the process of writing the execution result of any transaction into the transaction snapshot of the primary node.

For detailed descriptions of S1101 and S1102 shown in FIG. 13, refer to S1101 and S1102 shown in FIG. 11. For detailed descriptions of S702 to S704 shown in FIG. 13, refer to S702 to S704 shown in FIG. 7. For detailed descriptions of S603 shown in FIG. 13, refer to S603 shown in FIG. 6, and details are not described herein again.

In the embodiments of the present disclosure, the primary node respectively reads, through the starting time point and the ending time point at which the execution result of the transaction is written into the transaction snapshot of the primary node, the corresponding quantity of execution results that have been written into the transaction snapshot of the primary node, to detect the quantity change of the execution results that have been written into the transaction snapshot of the primary node in the process of writing the execution result of the transaction into the transaction snapshot of the primary node. The detection process is simple and is easy to implement.

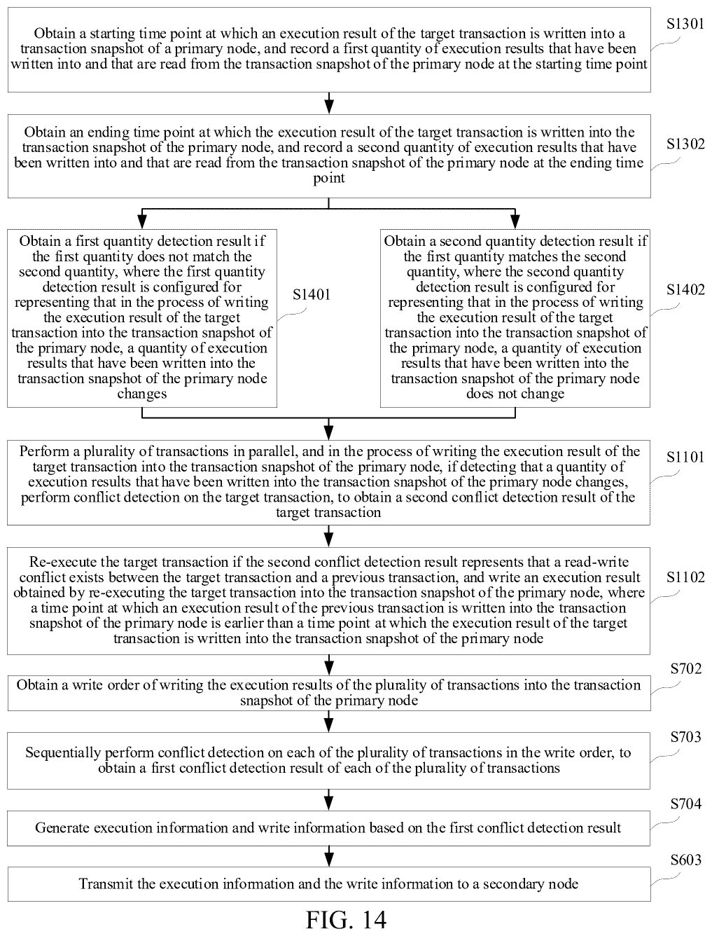

In an embodiment of the present disclosure, another transaction processing method is provided. The transaction processing method may be performed by a computer device serving as a primary node 401. As shown in FIG. 14, the transaction processing method may include S1401 and S1402, S1301 and S1302, S1101 and S1102, S702 to S704, and S603.

In the embodiments of the present disclosure, a primary node obtains a first quantity and a second quantity, and may determine, based on the first quantity and the second quantity, whether a quantity of execution results that have been written into a transaction snapshot of the primary node changes in a process of writing an execution result of any transaction into the transaction snapshot of the primary node.

S1401 and S1402 are described in detail below.

S1401: Obtain a first quantity detection result if the first quantity does not match the second quantity, where the first quantity detection result represents that in the process of writing the execution result of any transaction into the transaction snapshot of the primary node, a quantity of execution results that have been written into the transaction snapshot of the primary node changes.

In the embodiments of the present disclosure, if the first quantity does not match the second quantity, the first quantity detection result represents that in the process in which the execution result of any transaction is written into the transaction snapshot of the primary node, the quantity of execution results that have been written into the transaction snapshot of the primary node changes is obtained.

For example, following the foregoing example, for the transaction tx2, if the first quantity does not match the second quantity, the first quantity detection result represents that in the process in which the execution result of the transaction tx2 is written into the transaction snapshot of the primary node, the quantity of execution results that have been written into the transaction snapshot of the primary node changes is obtained. That is, at the KV operation stage of the transaction tx2, writing is completed in transaction execution.

For the transaction tx1, if the first quantity does not match the second quantity, the first quantity detection result represents that in the process in which the execution result of the transaction tx1 is written into the transaction snapshot of the primary node, the quantity of execution results that have been written into the transaction snapshot of the primary node changes is obtained. That is, at the KV operation stage of the transaction tx1, writing is completed in transaction execution.

For the transaction tx0, if the first quantity does not match the second quantity, the first quantity detection result represents that in the process in which the execution result of the transaction tx0 is written into the transaction snapshot of the primary node, the quantity of execution results that have been written into the transaction snapshot of the primary node changes is obtained. That is, at the KV operation stage of the transaction tx0, writing is completed in transaction execution.

S1402: Obtain a second quantity detection result if the first quantity matches the second quantity, where the second quantity detection result represents that in the process of writing the execution result of any transaction into the transaction snapshot of the primary node, the quantity of execution results that have been written into the transaction snapshot of the primary node does not change.

In the embodiments of the present disclosure, if the first quantity matches the second quantity, the second quantity detection result represents that in the process in which the execution result of any transaction is written into the transaction snapshot of the primary node, the quantity of execution results that have been written into the transaction snapshot of the primary node does not change is obtained.

For example, following the foregoing example, for the transaction tx2, the first quantity rmin is 0, and the second quantity snapshot.seq is 0. In this case, if the first quantity matches the second quantity, the second quantity detection result represents that in the process in which the execution result of the transaction tx2 is written into the transaction snapshot of the primary node, the quantity of execution results that have been written into the transaction snapshot of the primary node does not change is obtained. That is, at the KV operation stage of the transaction tx2, no writing is completed in transaction execution.

For the transaction tx1, the first quantity rmin is 1, and the second quantity snapshot.seq is 1. In this case, if the first quantity matches the second quantity, the second quantity detection result represents that in the process in which the execution result of the transaction tx1 is written into the transaction snapshot of the primary node, the quantity of execution results that have been written into the transaction snapshot of the primary node does not change is obtained. That is, at the KV operation stage of the transaction tx1, no writing is completed in transaction execution.

For the transaction tx0, the first quantity rmin is 2, and the second quantity snapshot.seq is 2. In this case, if the first quantity matches the second quantity, the second quantity detection result represents that in the process in which the execution result of the transaction tx0 is written into the transaction snapshot of the primary node, the quantity of execution results that have been written into the transaction snapshot of the primary node does not change is obtained. That is, at the KV operation stage of the transaction tx0, no writing is completed in transaction execution.

For detailed descriptions of S1301 and S1302 shown in FIG. 14, refer to S1301 and S1302 shown in FIG. 13. For detailed descriptions of S1101 and S1102 shown in FIG. 14, refer to S1101 and S1102 shown in FIG. 11. For detailed descriptions of S702 to S704 shown in FIG. 14, refer to S702 to S704 shown in FIG. 7. For detailed descriptions of S603 shown in FIG. 14, refer to S603 shown in FIG. 6, and details are not described herein again.

In the embodiments of the present disclosure, the primary node matches the first quantity with the second quantity, to quickly and accurately obtain the first quantity detection result or the second quantity detection result represents the quantity change of the execution results that have been written into the transaction snapshot of the primary node in the process in which the execution result of the transaction is written into the transaction snapshot of the primary node.

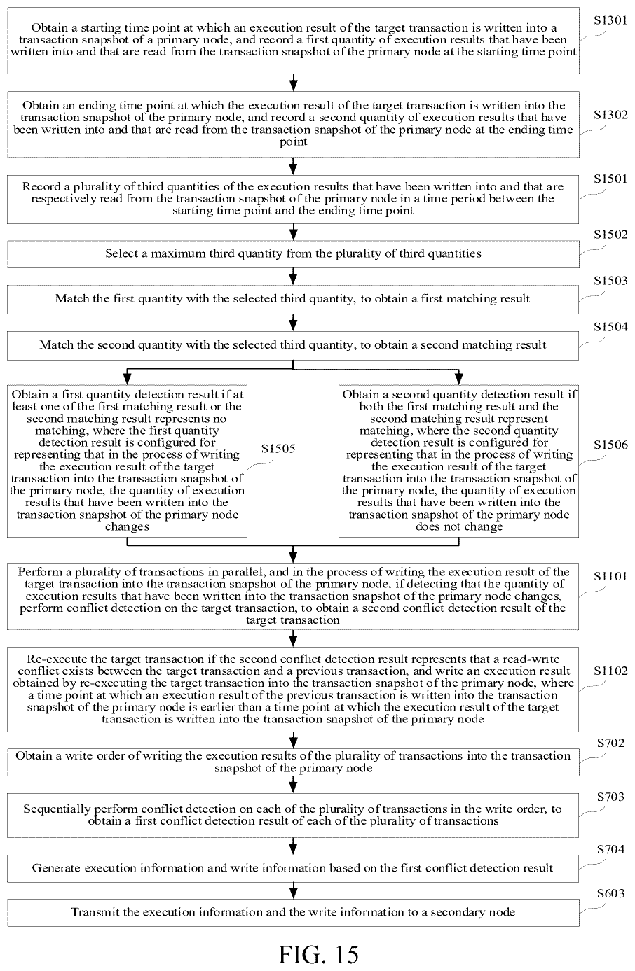

In an embodiment of the present disclosure, another transaction processing method is provided. The transaction processing method may be performed by a computer device serving as a primary node 401. As shown in FIG. 15, the transaction processing method may include S1501 to S1506, S1301 and S1302, S1101 and S1102, S702 to S704, and S603.

In the embodiments of the present disclosure, a primary node obtains a first quantity and a second quantity, may further obtain a third quantity, and may determine, based on the first quantity, the second quantity, and the third quantity, whether a quantity of execution results that have been written into a transaction snapshot of the primary node changes in a process of writing an execution result of any transaction into the transaction snapshot of the primary node.

S1501 to S1506 are described in detail below.

S1501: Record a plurality of third quantities of the execution results that have been written into and that are respectively read from the transaction snapshot of the primary node in a time period between a starting time point and an ending time point.

In the embodiments of the present disclosure, in the process of writing the execution result of any transaction into the transaction snapshot of the primary node, that is, in the time period between the starting time point and the ending time point, the primary node may record the plurality of third quantities of execution results that have been written into and that are respectively read from the transaction snapshot of the primary node.

In the embodiments of the present disclosure, the third quantity refers to a quantity of execution results that have been written into and that are read from the transaction snapshot of the primary node in the time period between the starting time point and the ending time point.

For example, following the foregoing example, for a transaction tx2, the plurality of third quantities r2 of execution results that have been written into and that are read from the transaction snapshot of the primary node in a time period between a moment 0 and a moment A is recorded.

For a transaction tx1, the plurality of third quantities r1 of execution results that have been written into and that are read from the transaction snapshot of the primary node in a time period between the moment A and a moment B is recorded.

For a transaction tx0, a plurality of third quantities r0 of execution results that have been written into and that are read from the transaction snapshot of the primary node in a time period between the moment B and a moment C is recorded.

S1502: Select a maximum third quantity from the plurality of third quantities.

In the embodiments of the present disclosure, the primary node records a plurality of third quantities corresponding to the execution results that have been written into and that are respectively read from the transaction snapshot of the primary node, and then may select the maximum third quantity from the plurality of third quantities.

For example, following the foregoing example, for the transaction tx2, a maximum third quantity is selected from the plurality of third quantities r2, and the selected maximum third quantity is recorded as r2max.

For the transaction tx1, a maximum third quantity is selected from the plurality of third quantities r1, and the selected maximum third quantity is recorded as r1max.

For the transaction tx0, a maximum third quantity is selected from the plurality of third quantities r0, and the selected maximum third quantity is recorded as r0max.

S1503: Match the first quantity with the selected third quantity, to obtain a first matching result.

In the embodiments of the present disclosure, the primary node matches the first quantity with the selected third quantity, to obtain the first matching result.

For example, following the foregoing example, for the transaction tx2, a first quantity rmin corresponding to the transaction tx2 is matched with the third quantity r2max, to obtain the first matching result.

For the transaction tx1, a first quantity rmin corresponding to the transaction tx1 is matched with the third quantity r1max, to obtain the first matching result.

For the transaction tx0, a first quantity rmin corresponding to the transaction tx0 is matched with the third quantity r0max, to obtain the first matching result.

S1504: Match the second quantity with the selected third quantity, to obtain a second matching result.

In the embodiments of the present disclosure, the primary node matches the second quantity with the selected third quantity, to obtain the second matching result.

For example, following the foregoing example, for the transaction tx2, a second quantity snapshot.seq corresponding to the transaction tx2 is matched with the third quantity r2max, to obtain the first matching result.

For the transaction tx1, a second quantity snapshot.seq corresponding to the transaction tx1 is matched with the third quantity r1max, to obtain the first matching result.

For the transaction tx0, a second quantity snapshot.seq corresponding to the transaction tx0 is matched with the third quantity r0max, to obtain the first matching result.

S1505: Obtain a first quantity detection result if at least one of the first matching result or the second matching result represents no matching, where the first quantity detection result represents that in the process of writing the execution result of any transaction into the transaction snapshot of the primary node, the quantity of execution results that have been written into the transaction snapshot of the primary node changes.

In the embodiments of the present disclosure, if at least one of the first matching result or the second matching result represents no matching, the first quantity detection result represents that in the process in which the execution result of any transaction is written into the transaction snapshot of the primary node, the quantity of execution results that have been written into the transaction snapshot of the primary node changes is obtained.

For example, following the foregoing example, for the transaction tx2, if the first quantity rmin corresponding to the transaction tx2 does not match the third quantity r2max, and/or the second quantity snapshot.seq corresponding to the transaction tx2 does not match the third quantity r2max, the first quantity detection result represents that in the process in which the execution result of the transaction tx2 is written into the transaction snapshot of the primary node, the quantity of execution results that have been written into the transaction snapshot of the primary node changes is obtained. That is, at a KV operation stage of the transaction tx2, writing is completed in transaction execution.

For the transaction tx1, if the first quantity rmin corresponding to the transaction tx1 does not match the third quantity r1max, and/or the second quantity snapshot.seq corresponding to the transaction tx1 does not match the third quantity r1max, the first quantity detection result represents that in the process in which the execution result of the transaction tx1 is written into the transaction snapshot of the primary node, the quantity of execution results that have been written into the transaction snapshot of the primary node changes is obtained. That is, at a KV operation stage of the transaction tx1, writing is completed in transaction execution.

For the transaction tx0, if the first quantity rmin corresponding to the transaction tx0 does not match the third quantity r0max, and/or the second quantity snapshot.seq corresponding to the transaction tx0 does not match the third quantity r0max, the second quantity detection result represents that in the process in which the execution result of the transaction tx0 is written into the transaction snapshot of the primary node, the quantity of execution results that have been written into the transaction snapshot of the primary node changes is obtained. That is, at a KV operation stage of the transaction tx0, writing is completed in transaction execution.

S1506: Obtain the second quantity detection result if both the first matching result and the second matching result represent matching, where the second quantity detection result represents that in the process of writing the execution result of any transaction into the transaction snapshot of the primary node, the quantity of execution results that have been written into the transaction snapshot of the primary node does not change.

In the embodiments of the present disclosure, if both the first matching result and the second matching result represent matching, the second quantity detection result represents that in the process in which the execution result of any transaction is written into the transaction snapshot of the primary node, the quantity of execution results that have been written into the transaction snapshot of the primary node does not change is obtained.

For example, following the foregoing example, for the transaction tx2, the first quantity rmin is 0, the second quantity snapshot.seq is 0, and the third quantity r2max is 0. In this case, the first quantity rmin matches the third quantity r2max and the second quantity snapshot.seq matches the third quantity r2max. The second quantity detection result represents that in the process in which the execution result of the transaction tx2 is written into the transaction snapshot of the primary node, the quantity of execution results that have been written into the transaction snapshot of the primary node does not change is obtained. That is, at the KV operation stage of the transaction tx2, no writing is completed in transaction execution.

For the transaction tx1, the first quantity rmin is 1, the second quantity snapshot.seq is 1, and the third quantity r1max is 1. In this case, the first quantity rmin matches the third quantity r1max and the second quantity snapshot.seq matches the third quantity r1max. The second quantity detection result represents that in the process in which the execution result of the transaction tx1 is written into the transaction snapshot of the primary node, the quantity of execution results that have been written into the transaction snapshot of the primary node does not change is obtained. That is, at the KV operation stage of the transaction tx1, no writing is completed in transaction execution.

For the transaction tx0, the first quantity rmin is 2, the second quantity snapshot.seq is 2, and the third quantity r0max is 2. In this case, the first quantity rmin matches the third quantity r0max and the second quantity snapshot.seq matches the third quantity r0max. The second quantity detection result represents that in the process in which the execution result of the transaction tx0 is written into the transaction snapshot of the primary node, the quantity of execution results that have been written into the transaction snapshot of the primary node does not change is obtained. That is, at the KV operation stage of the transaction tx0, no writing is completed in transaction execution.

For detailed descriptions of S1301 and S1302 shown in FIG. 15, refer to S1301 and S1302 shown in FIG. 13. For detailed descriptions of S1101 and S1102 shown in FIG. 15, refer to S1101 and S1102 shown in FIG. 11. For detailed descriptions of S702 to S704 shown in FIG. 15, refer to S702 to S704 shown in FIG. 7. For detailed descriptions of S603 shown in FIG. 15, refer to S603 shown in FIG. 6, and details are not described herein again.

In the embodiments of the present disclosure, the primary node matches the first quantity with the third quantity, and matches the second quantity with the third quantity, to quickly and accurately obtain the first quantity detection result or the second quantity detection result represents that in the process of writing the execution result of the transaction into the transaction snapshot of the primary node, the quantity change of the execution results that have been written into the transaction snapshot of the primary node.

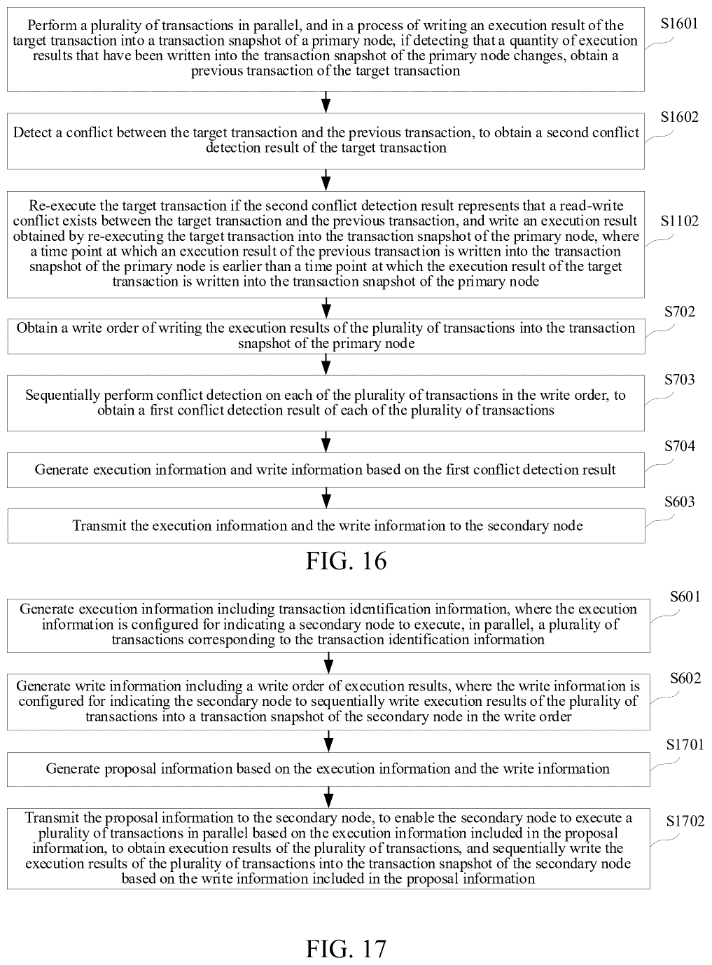

In an embodiment of the present disclosure, another transaction processing method is provided. The transaction processing method may be performed by a computer device serving as a primary node 401. As shown in FIG. 16, the transaction processing method may include S1601 and S1602, S1102, S702 to S704, and S603.

In the embodiments of the present disclosure, in a process of writing the execution result of any transaction into the transaction snapshot of the primary node, if detecting that the quantity of execution results that have been written into the transaction snapshot of the primary node changes, the primary node needs to perform conflict detection on any transaction, to obtain the second conflict detection result of any transaction.

In the embodiments of the present disclosure, the conflict detection refers to performing detection on whether there are conflicts about reading and writing between the transactions. The conflicts include a write-write conflict, a read-write conflict, and a write-read conflict.

In the embodiments of the present disclosure, the second conflict detection result is a conflict detection result of each transaction that is obtained by performing conflict detection on each transaction at a stage at which the primary node writes execution results of a plurality of transactions into the transaction snapshot of the primary node.

S1601 and S1602 are described in detail below.

S1601: Obtain a previous transaction of any transaction.

S1602: Detect a conflict between any transaction and the previous transaction, to obtain a second conflict detection result of any transaction.

For the previous transaction in the embodiments of the present disclosure, refer to descriptions in the foregoing embodiments. Details are not described herein again.

In the embodiments of the present disclosure, the primary node performs conflict detection on any transaction, to obtain the second conflict detection result of any transaction. Specifically, the primary node obtains the previous transaction of any transaction, and then detects the conflict between any transaction and the previous transaction, to obtain the second conflict detection result of any transaction.

For example, following the foregoing example, for a transaction tx2, in a process of writing an execution result of the transaction tx2 into a transaction snapshot of a primary node, if detecting that a quantity of execution results that have been written into the transaction snapshot of the primary node changes, the primary node obtains a previous transaction of the transaction tx2, and then detects a conflict between the transaction tx2 and the previous transaction, to obtain a second conflict detection result of the transaction tx2.

For a transaction tx1, in a process of writing an execution result of the transaction tx1 into a transaction snapshot of a primary node, if detecting that a quantity of execution results that have been written into the transaction snapshot of the primary node changes, the primary node obtains a previous transaction of the transaction tx1, and then detects a conflict between the transaction tx1 and the previous transaction, to obtain a second conflict detection result of the transaction tx1.

For a transaction tx0, in a process of writing an execution result of the transaction tx0 into a transaction snapshot of a primary node, if detecting that a quantity of execution results that have been written into the transaction snapshot of the primary node changes, the primary node obtains a previous transaction of the transaction tx0, and then detects a conflict between the transaction tx0 and the previous transaction, to obtain a second conflict detection result of the transaction tx0.

In an embodiment of the present disclosure, the process of detecting the conflict between any transaction and the previous transaction, to obtain the second conflict detection result of any transaction in S1602 may include:
obtaining a read-write set of any transaction and a read-write set of the previous transaction; and
detecting the conflict between any transaction and the previous transaction based on the read-write set of any transaction and the read-write set of the previous transaction, to obtain the second conflict detection result of any transaction.

To be specific, in one embodiment, the primary node implements conflict detection between any transaction and the previous transaction through the read-write set of any transaction and the read-write set of the previous transaction of any transaction.

For example, following the foregoing example, in a process in which conflict detection is performed on the transaction tx2, specifically, detection is performed on a conflict between the transaction tx2 and the previous transaction of the transaction tx2 based on a read-write set of the transaction tx2 and a read-write set of the previous transaction of the transaction tx2, to obtain a second conflict detection result Cₜₓ₂ of the transaction tx2.

In a process in which conflict detection is performed on the transaction tx1, specifically, detection is performed on a conflict between the transaction tx1 and the previous transaction of the transaction tx1 based on a read-write set of the transaction tx1 and a read-write set of the previous transaction of the transaction tx1, to obtain a second conflict detection result Cₜₓ₁ of the transaction tx1.

In a process in which conflict detection is performed on the transaction tx0, specifically, detection is performed on a conflict between the transaction tx0 and the previous transaction of the transaction tx0 based on a read-write set of the transaction tx0 and a read-write set of the previous transaction of the transaction tx0, to obtain a second conflict detection result Cₜₓ₀ of the transaction tx0.

In an embodiment of the present disclosure, the process of detecting the conflict between any transaction and the previous transaction, to obtain the second conflict detection result of any transaction in S1602 may include:
obtaining, if detecting, based on the read-write set of any transaction and the read-write set of the previous transaction, that the read-write conflict exists between any transaction and the previous transaction, the second conflict detection result represents that the read-write conflict exists between any transaction and the previous transaction; and
obtaining, if detecting, based on the read-write set of any transaction and the read-write set of the previous transaction, that no read-write conflict exists between any transaction and the previous transaction, a second conflict detection result represents that no read-write conflict exists between any transaction and the previous transaction.

In the embodiments of the present disclosure, if detecting, based on the read-write set of any transaction and the read-write set of the previous transaction, that the read-write conflict exists between any transaction and the previous transaction, the primary node obtains the second conflict detection result represents that the read-write conflict exists between any transaction and the previous transaction.

For example, following the foregoing example, for the transaction tx2, if a case that based on the read-write set of the transaction tx2 and the read-write set of the previous transaction of the transaction tx2, the read-write conflict exists between the transaction tx2 and the previous transaction of the transaction tx2 is detected, the second conflict detection result represents that the read-write conflict exists between the transaction tx2 and the previous transaction of the transaction tx2 is obtained.

For the transaction tx1, if a case that based on the read-write set of the transaction tx1 and the read-write set of the previous transaction of the transaction tx1, the read-write conflict exists between the transaction tx1 and the previous transaction of the transaction tx1 is detected, the second conflict detection result represents that the read-write conflict exists between the transaction tx1 and the previous transaction of the transaction tx1 is obtained.

For the transaction tx0, if a case that based on the read-write set of the transaction tx0 and the read-write set of the previous transaction of the transaction tx0, the read-write conflict exists between the transaction tx0 and the previous transaction of the transaction tx0 is detected, the second conflict detection result represents that the read-write conflict exists between the transaction tx0 and the previous transaction of the transaction tx0 is obtained.

In the embodiments of the present disclosure, if a case that based on the read-write set of any transaction and the read-write set of the previous transaction, no read-write conflict exists between any transaction and the previous transaction is detected, the second conflict detection result represents that no read-write conflict exists between any transaction and the previous transaction is obtained.

For example, following the foregoing example, for the transaction tx2, if a case that based on the read-write set of the transaction tx2 and the read-write set of the previous transaction of the transaction tx2, no read-write conflict exists between the transaction tx2 and the previous transaction of the transaction tx2 is detected, the second conflict detection result represents that the read-write conflict does not exist between the transaction tx2 and the previous transaction of the transaction tx2 is obtained.

For the transaction tx1, if a case that based on the read-write set of the transaction tx1 and the read-write set of the previous transaction of the transaction tx1, no read-write conflict exists between the transaction tx1 and the previous transaction of the transaction tx1 is detected, the second conflict detection result represents that the read-write conflict does not exist between the transaction tx1 and the previous transaction of the transaction tx1 is obtained.

For the transaction tx0, if a case that based on the read-write set of the transaction tx0 and the read-write set of the previous transaction of the transaction tx0, no read-write conflict exists between the transaction tx0 and the previous transaction of the transaction tx0 is detected, the second conflict detection result represents that no read-write conflict exists between the transaction tx0 and the previous transaction of the transaction tx0 is obtained.

For detailed descriptions of S1102 shown in FIG. 16, refer to S1102 shown in FIG. 11. For detailed descriptions of S702 to S704 shown in FIG. 16, refer to S702 to S704 shown in FIG. 7. For detailed descriptions of S603 shown in FIG. 16, refer to S603 shown in FIG. 6, and details are not described herein again.

In the embodiments of the present disclosure, in a process of performing conflict detection on transactions, the primary node obtains previous transactions of the transactions, and then detects conflicts between the transactions and the previous transactions, to obtain second conflict detection results of the transactions. In this way, conflict detection on the plurality of transactions is implemented quickly and accurately.

In an embodiment of the present disclosure, another transaction processing method is provided. The transaction processing method may be performed by a computer device serving as a primary node 401. As shown in FIG. 17, the transaction processing method may include S1701 and S1702 and S601 and S602.

S1701 and S1702 are described in detail below.

S1701: Generate proposal information based on execution information and write information.

S1702: Transmit the proposal information to a secondary node, to enable the secondary node to execute a plurality of transactions in parallel based on the execution information included in the proposal information, to obtain execution results of the plurality of transactions, and sequentially write the execution results of the plurality of transactions into a transaction snapshot of the secondary node based on the write information included in the proposal information.

In the embodiments of the present disclosure, the execution information generated by the primary node may be in a DAG form, and/or the write information generated by the primary node may also be in a DAG form.

In the embodiments of the present disclosure, the primary node may generate the proposal information based on the execution information in the DAG form and the write information in the DAG form, and then transmit the proposal information to the secondary node. That is, in the embodiments of the present disclosure, the primary node combines the execution information and the write information into the same information (namely, the proposal information), and transmits the same information to the secondary node.

In an embodiment of the present disclosure, the primary node may not need to combine the execution information and the write information into the same information (namely, the proposal information) and transmit the same information to the secondary node. That is, the primary node separately transmits the execution information and the write information to the secondary node. During actual application, transmission of the execution information and the write information may be flexibly adjusted according to a specific application scenario.

For detailed descriptions of S601 and S602 shown in FIG. 17, refer to S601 and S602 shown in FIG. 6, and details are not described herein again.

In the embodiments of the present disclosure, when transmitting the execution information and the write information to the secondary node, the primary node may combine the execution information and the write information into one piece of proposal information and transmit the proposal information to the secondary node, to save network resources consumed by information transmission, and improve information transmission efficiency.

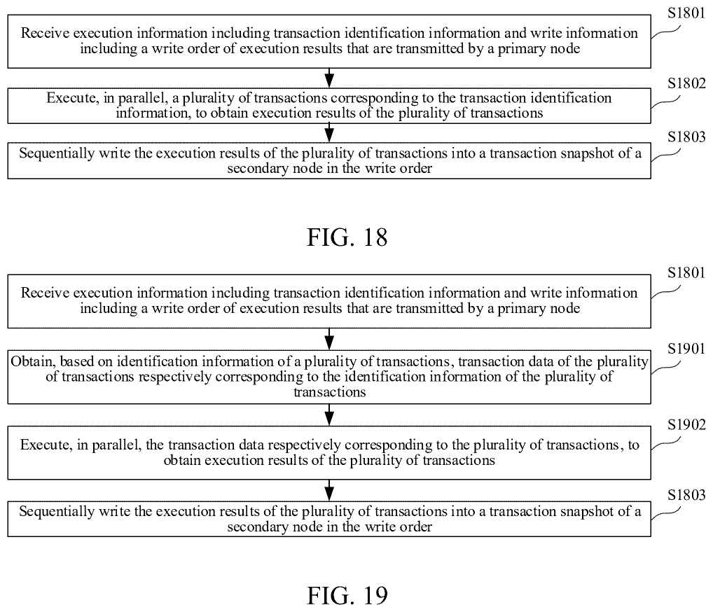

The embodiments shown in FIG. 6 to FIG. 17 are described from the perspective of the primary node. Implementation details of the technical solution of the embodiments of the present disclosure will be described in detail from the perspective of the secondary node with reference to FIG. 18 to FIG. 20.

FIG. 18 is a flowchart of a transaction processing method according to an embodiment of the present disclosure. The transaction processing method may be performed by a computer device serving as a secondary node 402. As shown in FIG. 18, the transaction processing method includes at least S1801 to S1803, which are described in detail below.

S1801: Receive execution information including transaction identification information and write information including a write order of execution results that are transmitted by a primary node.

In the embodiments of the present disclosure, the primary node generates the execution information including the transaction identification information and the write information including the write order of the execution results, and then transmits the execution information including the transaction identification information and the write information including the write order of the execution results to a secondary node. Correspondingly, the secondary node receives the execution information including the transaction identification information and the write information including the write order of the execution results that are transmitted by the primary node.

For example, the execution information includes identification information of three transactions: tx0, tx1, and tx2, and the write information includes a write order of execution results of the three transactions: tx2->tx0->tx1.

S1802: Execute, in parallel, a plurality of transactions corresponding to the transaction identification information, to obtain execution results of the plurality of transactions.

In the embodiments of the present disclosure, the secondary node receives the execution information including the transaction identification information and the write information including the write order of the execution results that are transmitted by the primary node, and then may execute, in parallel, the plurality of transactions corresponding to the transaction identification information, to obtain the execution results of the plurality of transactions.

For example, following the foregoing example, the secondary node executes the transaction tx0, the transaction tx1, and the transaction tx2 in parallel, to obtain the execution result of the transaction tx0, the execution result of the transaction tx1, and the execution result of the transaction tx2.

S1803: Sequentially write the execution results of the plurality of transactions into a transaction snapshot of the secondary node in the write order.

In the embodiments of the present disclosure, the secondary node obtains the execution results corresponding to the plurality of transactions, and then may sequentially write the execution results of the plurality of transactions into the transaction snapshot of the secondary node in the write order of the write information.

For example, following the foregoing example, the secondary node first writes the execution result of the transaction tx0 into the transaction snapshot of the secondary node, then writes the execution result of the transaction tx1 into the transaction snapshot of the secondary node, and finally writes the execution result of the transaction tx2 into the transaction snapshot of the secondary node.

In the embodiments of the present disclosure, the secondary node receives the execution information including the transaction identification information and the write information including the write order of the execution results that are transmitted by the primary node, and may execute, in parallel based on the execution information, the plurality of transactions corresponding to the transaction identification information, to obtain the execution results of the plurality of transactions, thereby improving transaction processing efficiency of the secondary node. In addition, the secondary node sequentially writes the execution results of the plurality of transactions into the transaction snapshot of the secondary node in the write order of the execution results in the write information, to ensure consistency between the execution results of the secondary node in the transaction snapshot and the execution results of the primary node in the transaction snapshot.

In an embodiment of the present disclosure, another transaction processing method is provided. The transaction processing method may be performed by a computer device serving as a secondary node 402. As shown in FIG. 19, the transaction processing method may include S1901 and S1902, S1801, and S1803.

S1901 and S1902 are described in detail below.

S1901: Obtain, based on identification information of a plurality of transactions, transaction data of the plurality of transactions respectively corresponding to the identification information of the plurality of transactions.

S1902: Execute, in parallel, the transaction data respectively corresponding to the plurality of transactions, to obtain execution results of the plurality of transactions.

In the embodiments of the present disclosure, the secondary node may obtain, based on the identification information of the plurality of transactions, the transaction data corresponding to the plurality of transactions respectively corresponding to the identification information of the plurality of transactions, and then execute, in parallel, the transaction data respectively corresponding to the plurality of transactions, to obtain the execution results of the plurality of transactions.

For example, following the foregoing example, the execution information includes identification information of three transactions: tx0, tx1, and tx2. Therefore, transaction data corresponding to the transaction tx0 is obtained, transaction data corresponding to the transaction tx1 is obtained, and transaction data corresponding to the transaction tx2 are obtained. Then, the transaction data corresponding to the transaction tx0, the transaction data corresponding to the transaction tx1, and the transaction data corresponding to the transaction tx2 are executed in parallel, to obtain an execution result of the transaction tx0, an execution result of the transaction tx1, and an execution result of the transaction tx2.

In an embodiment of the present disclosure, the process of executing, in parallel, the transaction data respectively corresponding to the plurality of transactions, to obtain the execution results of the plurality of transactions in S1902 may include:
updating, in a process of executing, in parallel, the transaction data respectively corresponding to the plurality of transactions, an execution status of any transaction to an execution complete state if detecting that execution of any transaction is completed.

To be specific, in one embodiment, in the process in which the transaction data respectively corresponding to the plurality of transactions is executed in parallel, if a case that execution of any transaction is completed is detected, the execution status of any transaction is updated, specifically, updated to the execution completion status, to facilitate transaction management.

For detailed descriptions of S1801 and S1803 shown in FIG. 19, refer to S1801 and S1803 shown in FIG. 18, and details are not described herein again.

In the embodiments of the present disclosure, the secondary node obtains the transaction data of the plurality of transactions corresponding to the identification information of the plurality of transactions, and executes the transaction data of the plurality of transactions in parallel, to quickly and accurately obtain the execution results of the plurality of transactions.

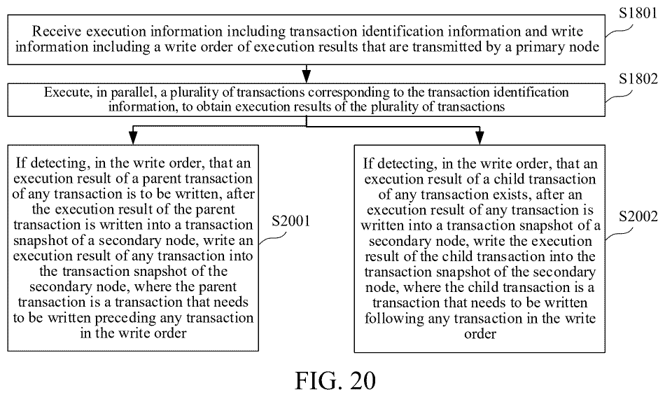

In an embodiment of the present disclosure, another transaction processing method is provided. The transaction processing method may be performed by a computer device serving as a secondary node 402. As shown in FIG. 20, the transaction processing method may include S2001 and S2002 and S1801 and S1802.

S2001 and S2002 are described in detail below.

S2001: If detecting, in a write order, that an execution result of a parent transaction of any transaction is to be written, after the execution result of the parent transaction is written into a transaction snapshot of a secondary node, write the execution result of any transaction into the transaction snapshot of the secondary node, where the parent transaction is a transaction that needs to be written preceding any transaction in the write order.

In the embodiments of the present disclosure, the parent transaction of any transaction is a transaction that precedes any transaction in the write order. For example, write information includes a write order of execution results of three transactions: tx2->tx0->tx1. A parent transaction of the transaction tx0 is a parent transaction of the transaction tx2 and a parent transaction of the transaction tx2, a parent transaction of the transaction tx1 is a parent transaction of the transaction tx0 and a parent transaction of the transaction tx0, and the rest is deduced by analogy.

In the embodiments of the present disclosure, if a case that the execution result of the parent transaction of any transaction is to be written in the write order is detected, after the execution result of the parent transaction is written into the transaction snapshot of the secondary node, the execution result of any transaction is written into the transaction snapshot of the secondary node, to ensure write accuracy between a plurality of transactions.

S2002: If detecting, in the write order, that an execution result of a child transaction of any transaction exists, after the execution result of any transaction is written into the transaction snapshot of the secondary node, write the execution result of the child transaction into the transaction snapshot of the secondary node, where the child transaction is a transaction that needs to be written following any transaction in the write order.

In the embodiments of the present disclosure, the child transaction of any transaction is a transaction that follows any transaction in the write order. For example, write information includes a write order of execution results of three transactions: tx2->tx0->tx1. A child transaction of the transaction tx2 is a child transaction of the transaction tx0 and a child transaction of the transaction tx0, a child transaction of the transaction tx0 is a child transaction of the transaction tx1 and a child transaction of the transaction tx1, and the rest is deduced by analogy.

In the embodiments of the present disclosure, if a case that the execution result of the child transaction of any transaction exists in the write order is detected, after the execution result of any transaction is written into the transaction snapshot of the secondary node, the execution result of the child transaction is written into the transaction snapshot of the secondary node, to trigger writing of the child transaction of any transaction.

For detailed descriptions of S1801 and S1802 shown in FIG. 20, refer to S1801 and S1802 shown in FIG. 18, and details are not described herein again.

In the embodiments of the present disclosure, after writing the execution result of the parent transaction into the transaction snapshot of the secondary node, the secondary node writes the execution result of the transaction into the transaction snapshot of the secondary node, to ensure write accuracy between a plurality of transactions. In addition, after writing the execution result of the transaction into the transaction snapshot of the secondary node, the secondary node further writes the execution result of the child transaction into the transaction snapshot of the secondary node, which triggers writing of the child transaction of the transaction, thereby further ensuring the write accuracy between the plurality of transactions.

The following provides detailed descriptions of a specific scenario of the embodiments of the present disclosure.

A write-write conflict optimization scheme is as follows.

First, generation processes of a primary node for an execution DAG (also referred to as ED) and a write DAG (also referred to as WD) are described.

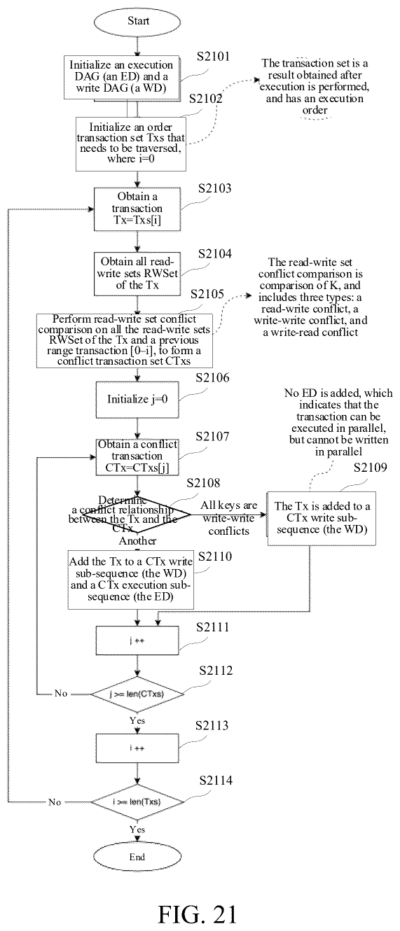

FIG. 21 is a flowchart of a transaction processing method according to an embodiment of the present disclosure. As shown in FIG. 21, the transaction processing method includes at least S2101 to S2114, which are described in detail below.

S2101: Initialize an execution DAG and a write DAG.

For example, initializing the execution DAG may be recorded as a first sequence Q1=[ ]. Similarly, initializing the write DAG may be recorded as a second sequence Q2=[ ].

S2102: Initialize an order transaction set Txs that needs to be traversed, where i=0.

Following the foregoing example, it is assumed that Txs={tx2, tx0, tx1}, where i corresponds to each transaction in the transaction set Txs, that is, i=0 corresponds to the transaction tx2, i=1 corresponds to the transaction tx0, and i=2 corresponds to the transaction tx1.

S2103: Obtain a transaction Tx=Txs[i].

The transaction set Txs is traversed to implement conflict detection on each transaction in the transaction set Txs.

Following the foregoing example, the transaction tx2 is then obtained.

S2104: Obtain all read-write sets RWSet of the Tx.

Following the foregoing example, all read-write sets RWSet of the transaction tx2 are then obtained.

S2105: Perform read-write set conflict comparison on all the read-write sets RWSet of the Tx and a previous range transaction [0-i], to form a conflict transaction set CTxs.

The read-write set conflict comparison is comparison of K, and includes three types: a read-write conflict, a write-write conflict, and a write-read conflict.

Following the foregoing example, the read-write set conflict comparison is then performed on all the read-write sets RWSet of the transaction tx2 and the previous range transaction [0-i], to form the conflict transaction set CTxs.

S2106: Initialize j=0.

Following the foregoing example, it is assumed that Txs={ctx10, ctx6}, where j corresponds to each conflict transaction in the conflict transaction set CTxs. That is, j=0 corresponds to a conflict transaction ctx10, and j=1 corresponds to a conflict transaction ctx6.

S2107: Obtain a conflict transaction ctx=CTxs[j].

The conflict transaction set CTxs is traversed to implement conflict detection on each transaction in the transaction set Txs based on conflict transactions in the conflict transaction set CTxs.

S2108: Detect a conflict relationship between the Tx and the CTx; and if all keys are the write-write conflicts, perform S2109, and if all the keys are other conflicts, perform S2110.

Following the foregoing example, a conflict relationship between the transaction tx2 and the conflict transaction ctx10 is then detected.

If all the keys are the write-write conflicts, the transaction tx2 is added to a CTx write sub-sequence but not to an execution sub-sequence, which represents that the transaction tx2 can be executed in parallel but cannot be written in parallel (that is, the transaction tx2 can be written in series only). Except for a case that all the keys are the write-write conflicts, the transaction tx2 is added to the CTx write sub-sequence and the execution sub-sequence.

For ease of understanding, Table 1 is an example table of adding a transaction to the CTx write sub-sequence.

TABLE 1

| 0 | 1 | 2 | 3 | 4 | 5 | 6 |
|---|---|---|---|---|---|---|
| Nil | Nil | [0, 1] | [2] | Nil | [4] | [3, 5] |

As shown in Table 1, the CTx has 7 transactions tx in total. If a transaction tx2 corresponds to a transaction tx0 and the transaction tx1, it represents that the transaction tx0 and the transaction tx1 are written before the transaction tx2; if a transaction tx3 corresponds to the transaction tx2, it represents that the transaction tx2 is written before the transaction tx3; and for a transaction tx5 and a transaction tx6, the rest is deduced by analogy. If the transaction tx0, the transaction tx1, and a transaction tx4 respectively correspond to Nil, it represents that there is no write time sequence relationship between the transaction tx0, the transaction tx1, and the transaction tx4.

Similarly, the transaction is added to the CTx execution sub-sequence, and the rest is deduced by analogy.

S2109: Tx is added to the CTx write sub-sequence (namely, the WD).

S2110. Tx is added to the CTx write sub-sequence and the CTx execution sub-sequence (namely, the ED).

S2111: j++.

Following the foregoing example, a conflict transaction ctx6 is then obtained.

S2112: Detect whether j is greater than or equal to a quantity of conflict transactions in the conflict transaction set CTxs, that is, detect whether j is greater than or equal to len(CTxs); and if yes, perform S2113; or if not, perform S2107.

Following the foregoing example, in this case, if j=1, and len(CTxs)=2, j<len(CTxs). In this case, S2107 needs to be returned, S2107 to S2112 are repeatedly performed until j≥len(CTxs), and a loop is exited.

S2113: i++.

Following the foregoing example, the transaction tx0 is then obtained.

S2114: Detect whether i is greater than or equal to a quantity of transactions in the Txs, that is, detect whether i is greater than or equal to len(Txs); and if yes, end a procedure; or if not, perform S2103.

Following the foregoing example, in this case, if i=1, and len(Txs)=3, i<len(Txs). In this case, S2103 needs to be returned, S2103 to S2114 are repeatedly performed until i≥len(Txs), and a loop is exited.

In this case, the primary node obtains the execution DAG and the write DAG that correspond to a plurality of transactions.

Next, a process in which a secondary node executes the plurality of transactions in parallel based on the ED and writes execution results of the transactions into a transaction snapshot of the secondary node based on the WD is described.

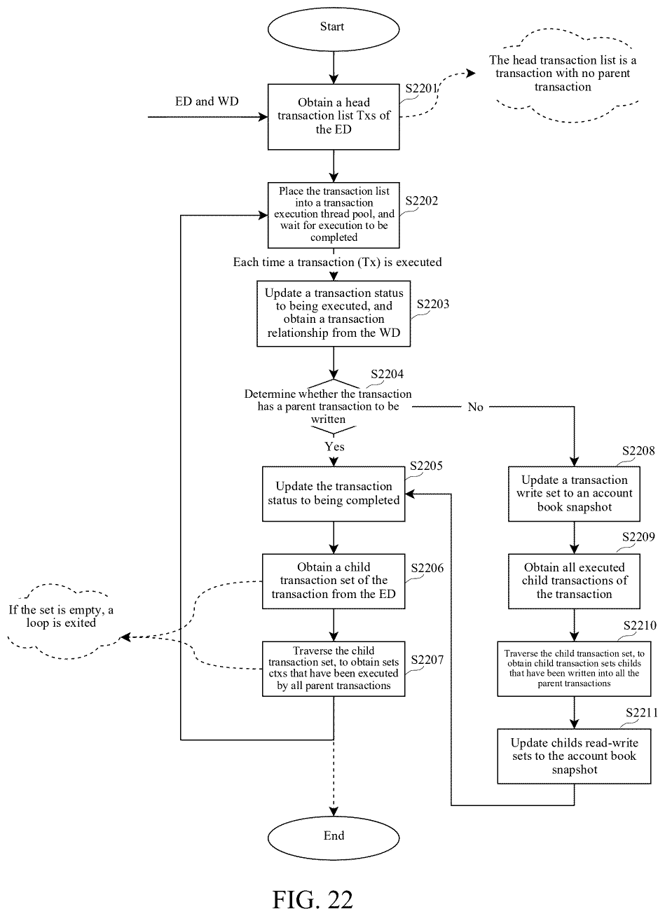

FIG. 22 is a flowchart of a transaction processing method according to an embodiment of the present disclosure. As shown in FIG. 22, the transaction processing method includes at least S2201 to S2211, which are described in detail below.

S2201: Obtain a head transaction list Txs of an ED.

The head transaction list Txs is a transaction with no parent transaction.

S2202: Place the transaction list into a transaction execution thread pool, and wait for execution to be completed.

S2203: Update a transaction status to being executed each time a transaction (Tx) is executed, and obtain a transaction relationship from a WD.

S2204: Detect whether there is a parent transaction to be executed; and if yes, perform S2205, or if no, perform S2208.

S2205: Update the transaction status to being completed.

S2206: Obtain a child transaction set of the transaction from the ED.

S2207: Traverse the child transaction set, to obtain sets ctxs that have been executed by all parent transactions.

S2208: Update a transaction write set to a transaction snapshot (also referred to as an account book snapshot).

S2209: Obtain all executed child transactions of the transaction.

S2210: Traverse the child transaction set, to obtain child transaction sets childs that have been written into all the parent transactions.

S2211: Update childs read-write sets to the transaction snapshot.

In this case, the secondary node completes execution of a plurality of transactions in parallel based on the ED and writes execution results of the transactions into the transaction snapshot of the secondary node based on the WD.

In the embodiments of the present disclosure, for a write-write conflict, the DAG generated by the primary node in the related art is adjusted to the execution DAG and the write DAG, so that the secondary node may execute the plurality of transactions in parallel based on the execution DAG, to obtain execution results corresponding to the plurality of transactions, and write the execution results of the plurality of transactions into the transaction snapshot of the secondary node based on the write DAG, thereby improving transaction processing efficiency of the secondary node, and ensuring consistency between the execution results of the secondary node in the transaction snapshot and the execution results of the primary node in the transaction snapshot.

The read-write conflict optimization scheme is as follows.

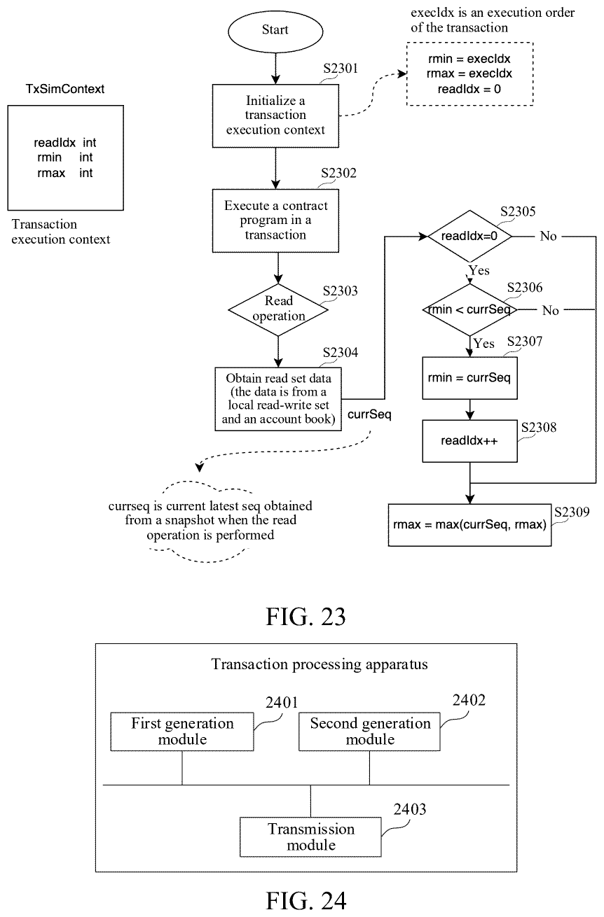

FIG. 23 is a flowchart of a transaction processing method according to an embodiment of the present disclosure. As shown in FIG. 23, the transaction processing method includes at least S2301 to S2309, which are described in detail below.

First, related parameters used in the embodiments of the present disclosure are described.

TxSimContext represents a transaction execution context, and an object is created for each transaction before the transaction is executed.

Three variables: readIdx, rmin, and rmax, are added to TxSimContext.

(A) readIdx is configured for representing a first read operation, to facilitate processing on rmin.

(B) rmin represents a seq value obtained when the first read operation is performed in an execution process of the transaction context, and the value is, by default, seq obtained when TxSimContext is created (seq refers to a quantity of execution results of transactions that have been added to a transaction snapshot when TxSimContext is created).

(C) rmax represents a maximum seq value of the read operation in an execution process of the transaction context, and the value is also, by default, seq when TxSimContext is created.

Next, a corresponding procedure is described.

S2301: Initialize a transaction execution context.

S2302: Execute an intelligent contract in a transaction.

S2303: A read operation.

S2304: Obtain read set data, where data is from a local read-write set and a transaction snapshot.

S2305: Detect whether readIdx is equal to 0, that is, detect whether readIdx is equal to 0; and if yes, perform S2306, or if not, perform S2309.

S2306: Detect whether rmin is less than currSeq, that is, detect whether rmin is less than currSeq; and if yes, perform S2307, or if not, perform S2309.

currSeq represents a seq value read in real time when the read operation is performed.

S2307: Assign currSeq to rmin, that is, rmin=currSeq.

S2308: ReadIdx++.

S2309: rmax=max (currSeq, rmax).

In short, in the embodiments of the present disclosure, if the following condition is satisfied:
(TxSimContext.rmin==TxSimContext.rmax)&&(TxSimContext.rmax==Snapshot.CurrSeq),
when the read operation is performed, TxSimContxet has no execution conflict with any other transaction. Although a transaction may be added to the snapshot during execution, the transaction is not added to the snapshot when the read operation is performed. In this case, it means that there is no problem in an execution result of the transaction, and the transaction does not need to be repeatedly executed.

In this way, the primary node reduces repeated execution of transactions of the primary node, to avoid a waste of resources of the primary node.

For detailed descriptions of S2301 to S2309 shown in FIG. 23, refer to the foregoing embodiments, and details are not described herein again.

In the embodiments of the present disclosure, for a read-write conflict, a process of writing an execution result of a transaction into a transaction snapshot of a primary node is detected by adding an execution context mark, thereby avoiding a phenomenon that the primary node repeatedly executes transactions, and saving resources of the primary node.

FIG. 24 is a block diagram of a transaction processing apparatus according to an embodiment of the present disclosure. As shown in FIG. 24, the transaction processing apparatus includes:

a first generation module 2401, configured to generate execution information including transaction identification information, the execution information being configured to indicate that a plurality of transactions corresponding to the transaction identification information are to be executed in parallel by a secondary node;
a second generation module 2402, configured to generate write information including a write order of execution results, the write information being configured to indicate that execution results of the plurality of transactions are to be sequentially written by the secondary node into a transaction snapshot of the secondary node according to the write order; and
a transmission module 2403, configured to transmit the execution information and the write information to the secondary node.

In an embodiment of the present disclosure, the first generation module 2401 and the second generation module 2402 are specifically configured to:
execute the plurality of transactions in parallel, and write the execution results of the plurality of transactions that are obtained by executing the plurality of transactions in parallel into a transaction snapshot of the primary node;
obtain a primary write order of writing the execution results of the plurality of transactions into the transaction snapshot of the primary node;
sequentially perform conflict detection on each of the plurality of transactions in the primary write order, to obtain a first conflict detection result of each of the plurality of transactions; and
generate the execution information and the write information based on the first conflict detection result.

In an embodiment of the present disclosure, the first generation module 2401 and the second generation module 2402 are further specifically configured to:
add identification information of any transaction to a first sequence, and sequentially add the identification information of any transaction to a second sequence in response to the first conflict detection result indicating that at least one of a read-write conflict or a write-read conflict exists between any transaction and a previous transaction, where a time point at which an execution result of the previous transaction is written into the transaction snapshot of the primary node is earlier than a time point at which the execution result of any transaction is written into the transaction snapshot of the primary node;
sequentially add the identification information of any transaction to the second sequence in response to the first conflict detection result indicating that only a write-write conflict exists between any transaction and the previous transaction;
generate the execution information based on identification information of the plurality of transactions included in the first sequence; and
generate the write information based on identification information of the plurality of transactions included in the second sequence and in an arrangement order of the plurality of transactions in the second sequence.

In an embodiment of the present disclosure, the first generation module 2401 and the second generation module 2402 are further specifically configured to:
obtain a previous transaction of any transaction in a process of performing conflict detection on any transaction in the write order, where a time point at which an execution result of the previous transaction is written into the transaction snapshot of the primary node is earlier than a time point at which an execution result of any transaction is written into the transaction snapshot of the primary node; and
detect a conflict between any transaction and the previous transaction, to obtain the first conflict detection result of any transaction.

In an embodiment of the present disclosure, the first generation module 2401 and the second generation module 2402 are further specifically configured to:
obtain a read-write set of any transaction and a read-write set of the previous transaction; and
detect the conflict between any transaction and the previous transaction based on the read-write set of any transaction and the read-write set of the previous transaction, to obtain the first conflict detection result of any transaction.

In an embodiment of the present disclosure, a quantity of previous transactions of any transaction is more than one; and the first generation module 2401 and the second generation module 2402 are further specifically configured to:
obtain the read-write set of any transaction and the read-write sets of the plurality of previous transactions; and
detect conflicts between any transaction and the plurality of previous transactions based on the read-write set of any transaction and the read-write sets of the plurality of previous transactions, to obtain a plurality of first conflict detection results of any transaction.

In an embodiment of the present disclosure, the first generation module 2401 and the second generation module 2402 are further specifically configured to:
in a process of writing the execution result of any transaction into the transaction snapshot of the primary node, if detecting that a quantity of execution results that have been written into the transaction snapshot of the primary node changes, perform conflict detection on any transaction, to obtain a second conflict detection result of any transaction; and
re-execute any transaction if the second conflict detection result represents that the read-write conflict exists between any transaction and the previous transaction, and write an execution result obtained by re-executing any transaction into the transaction snapshot of the primary node, where the time point at which the execution result of the previous transaction is written into the transaction snapshot of the primary node is earlier than the time point at which the execution result of any transaction is written into the transaction snapshot of the primary node.

In an embodiment of the present disclosure, the first generation module 2401 and the second generation module 2402 are further specifically configured to:
obtain a starting time point at which the execution result of any transaction is written into the transaction snapshot of the primary node, and record a first quantity of execution results that have been written into and that are read from the transaction snapshot of the primary node at the starting time point;
obtain an ending time point at which the execution result of any transaction is written into the transaction snapshot of the primary node, and record a second quantity of execution results that have been written into and that are read from the transaction snapshot of the primary node at the ending time point; and
detect, based on the first quantity and the second quantity, a quantity change of the execution results that have been written into the transaction snapshot of the primary node in the process of writing the execution result of any transaction into the transaction snapshot of the primary node.

In an embodiment of the present disclosure, the first generation module 2401 and the second generation module 2402 are further specifically configured to:
obtain a first quantity detection result if the first quantity does not match the second quantity, where the first quantity detection result represents that in the process of writing the execution result of any transaction into the transaction snapshot of the primary node, a quantity of execution results that have been written into the transaction snapshot of the primary node changes; and
obtain a second quantity detection result if the first quantity matches the second quantity, where the second quantity detection result represents that in the process of writing the execution result of any transaction into the transaction snapshot of the primary node, a quantity of execution results that have been written into the transaction snapshot of the primary node does not change.

In an embodiment of the present disclosure, the first generation module 2401 and the second generation module 2402 are further specifically configured to:
record a plurality of third quantities of the execution results that have been written into and that are respectively read from the transaction snapshot of the primary node in a time period between the starting time point and the ending time point;
select a maximum third quantity from the plurality of third quantities;
match the first quantity with the selected third quantity, to obtain a first matching result;
match the second quantity with the selected third quantity, to obtain a second matching result;
obtain a first quantity detection result if at least one of the first matching result or the second matching result represents no matching, where the first quantity detection result represents that in the process of writing the execution result of any transaction into the transaction snapshot of the primary node, the quantity of execution results that have been written into the transaction snapshot of the primary node changes; and
obtain a second quantity detection result if both the first matching result and the second matching result represent matching, where the second quantity detection result represents that in the process of writing the execution result of any transaction into the transaction snapshot of the primary node, a case that the quantity of execution results that have been written into the transaction snapshot of the primary node does not change is detected.

In an embodiment of the present disclosure, the first generation module 2401 and the second generation module 2402 are further specifically configured to:
obtain the previous transaction of any transaction; and
detect the conflict between any transaction and the previous transaction, to obtain the second conflict detection result of any transaction.

In an embodiment of the present disclosure, the first generation module 2401 and the second generation module 2402 are further specifically configured to:
obtain, if detecting, based on the read-write set of any transaction and the read-write set of the previous transaction, that the read-write conflict exists between any transaction and the previous transaction, the second conflict detection result represents that the read-write conflict exists between any transaction and the previous transaction; and
obtain, if detecting, based on the read-write set of any transaction and the read-write set of the previous transaction, that no read-write conflict exists between any transaction and the previous transaction, a second conflict detection result represents that no read-write conflict exists between any transaction and the previous transaction.

In an embodiment of the present disclosure, the transmission module 2403 is specifically configured to:
generate proposal information based on the execution information and the write information; and
transmit the proposal information to the secondary node, to enable the secondary node to execute the plurality of transactions in parallel based on the execution information included in the proposal information, to obtain the execution results of the plurality of transactions, and sequentially write the execution results of the plurality of transactions into the transaction snapshot of the secondary node based on the write information included in the proposal information.

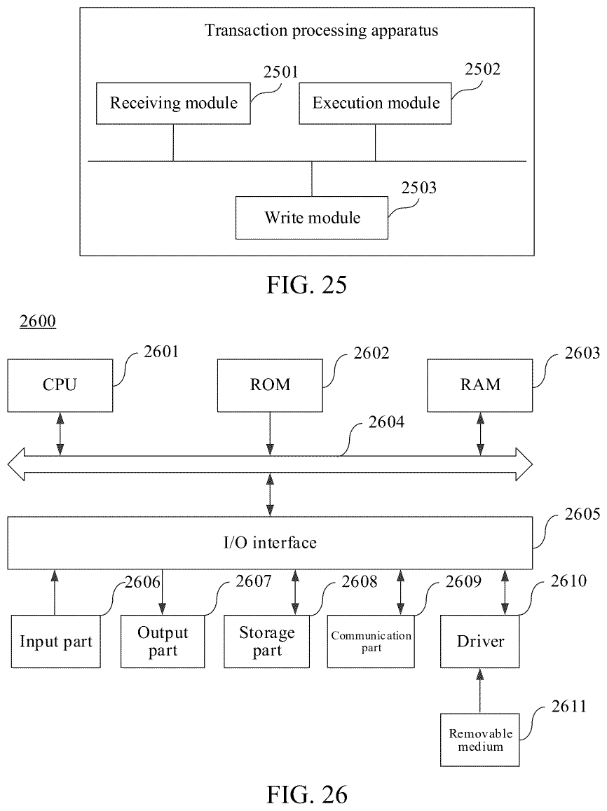

FIG. 25 is a block diagram of a transaction processing apparatus according to an embodiment of the present disclosure. As shown in FIG. 25, the transaction processing apparatus includes:
a receiving module 2501, configured to receive execution information including transaction identification information and write information including a write order of execution results that are transmitted by a primary node;
an execution module 2502, configured to execute, in parallel, a plurality of transactions corresponding to the transaction identification information, to obtain execution results of the plurality of transactions; and
a write module 2503, configured to sequentially write the execution results of the plurality of transactions into a transaction snapshot of the secondary node in the write order.

In an embodiment of the present disclosure, the transaction identification information includes identification information of the plurality of transactions; and the execution module 2502 is specifically configured to:
obtain, based on the identification information of the plurality of transactions, transaction data of the plurality of transactions corresponding to the identification information of the plurality of transactions; and
execute, in parallel, the transaction data respectively corresponding to the plurality of transactions, to obtain the execution results of the plurality of transactions.

In an embodiment of the present disclosure, the transaction identification information includes identification information of the plurality of transactions; and the execution module 2502 is further specifically configured to:
update, in a process of executing, in parallel, the transaction data respectively corresponding to the plurality of transactions, an execution status of any transaction to an execution complete state if detecting that execution of any transaction is completed.

In an embodiment of the present disclosure, the write module 2503 is specifically configured to:
if detecting, in a write order, that an execution result of a parent transaction of any transaction is to be written, after the execution result of the parent transaction is written into a transaction snapshot of a secondary node, write the execution result of any transaction into the transaction snapshot of the secondary node, where the parent transaction is a transaction that needs to be written before any transaction in the write order; and
if detecting, in the write order, that an execution result of a child transaction of any transaction exists, after the execution result of any transaction is written into the transaction snapshot of the secondary node, write the execution result of the child transaction into the transaction snapshot of the secondary node, where the child transaction is a transaction that needs to be written after any transaction in the write order.

The apparatuses provided in the foregoing embodiments and the method provided in the foregoing embodiments belong to the same idea. Specific operation manners of the modules and units have been described in detail in the method embodiments.

The embodiments of the present disclosure further provide an electronic device, including one or more processors; and a memory, configured to store one or more programs, the one or more programs, when executed by the one or more processors, causing the electronic device to implement the transaction processing method described above.

FIG. 26 is a schematic diagram of a structure of a computer system adapted to implement an electronic device according to an embodiment of the present disclosure.

A computer system 2600 of the electronic device shown in FIG. 26 is merely an example, and does not constitute any limitation on functions and use ranges of the embodiments of the present disclosure.

As shown in FIG. 26, the computer system 2600 includes a central processing unit (CPU) 2601, which may perform various suitable actions and processing according to a program stored in a read-only memory (ROM) 2602 or a program loaded from a storage part 2608 into a random access memory (RAM) 2603, for example, perform the method described in the foregoing embodiments. The RAM 2603 further stores various programs and data required for operating the system. The CPU 2601, the ROM 2602, and the RAM 2603 are connected to each other by using a bus 2604. An input/output (I/O) interface 2605 is also connected to the bus 2604.

The following components are connected to the I/O interface 2605: an input part 2606 including a keyboard, a mouse, or the like; an output part 2607 including a cathode ray tube (CRT), a liquid crystal display (LCD), a speaker, or the like; a storage part 2608 including a hard disk, or the like; and a communication part 2609 including a network interface card such as a local area network (LAN) card or a modem. The communication part 2609 performs communication processing through a network such as the internet. A driver 2610 is also connected to the I/O interface 2605 as required. A removable medium 2611, such as a magnetic disk, an optical disc, a magneto-optical disk, or a semiconductor memory, is installed on the drive 2610 as required, so that a computer program read from the removable medium is installed into the storage part 2608 as required.

Particularly, according to an embodiment of the present disclosure, the processes described above by referring to the flowcharts may be implemented as computer software programs. For example, an embodiment of the present disclosure includes a computer program product. The computer program product includes a computer program stored in a computer-readable medium. The computer program includes a computer program configured for performing a method shown in the flowchart. In such an embodiment, by using the communication part 2609, the computer program may be downloaded and installed from a network, and/or installed from the removable medium 2611. When the computer program is executed by the CPU 2601, the various functions defined in the system of the present disclosure are executed.

The computer-readable medium shown in the embodiments of the present disclosure may be a computer-readable signal medium or a computer-readable storage medium or any combination thereof. The computer-readable medium may be, for example an electric, magnetic, optical, electromagnetic, infrared, or semi-conductive system, apparatus, or component, or any combination thereof. A more specific example of the computer-readable medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any appropriate combination thereof. In the present disclosure, the computer-readable medium may be any tangible medium containing or storing a program, and the program may be used by or used in combination with an instruction execution system, apparatus, or device. In the present disclosure, the computer-readable signal medium may include a data signal transmitted in a baseband or as part of a carrier, and stores a computer-readable computer program. The data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may transmit, propagate, or transmit a program that is used by or used in combination with an instruction execution system, apparatus, or device. The computer program included in the computer-readable medium may be transmitted by using any suitable medium, including but not limited to: a wireless medium, a wire, or the like, or any suitable combination thereof.

The flowcharts and block diagrams in the accompanying drawings illustrate possible system architectures, functions, and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions configured for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

Related units described in the embodiments of the present disclosure may be implemented in a software manner, or may be implemented in a hardware manner, and the unit described can also be set in a processor. Names of the units do not constitute a limitation on the units in a specific case.

According to another aspect of the present disclosure, a computer-readable medium is further provided, having a computer program stored therein, the computer program, when being executed by a processor, implementing the transaction processing method described above. The computer-readable medium may be included in the electronic device described in the foregoing embodiments, or may exist alone and is not disposed in the electronic device.

According to another aspect of the present disclosure, a computer program product or a computer program is further provided, the computer program product or the computer program including computer instructions, the computer instructions being stored in a computer-readable medium. A processor of a computer device reads the computer instructions from the computer-readable medium and executes the computer instructions, to cause the computer device to perform the transaction processing method provided in the foregoing various embodiments.

The foregoing descriptions are merely exemplary embodiments of the present disclosure, and are not intended to limit the implementations of the present disclosure. A person of ordinary skill in the art may conveniently make variations or modifications according to the main idea and spirit of the present disclosure. Therefore, the protection scope of the present disclosure shall be subject to the protection scope of the claims.

What is claimed is:

1. A transaction processing method, performed by a computer device serving as a primary node, the method comprising:
generating execution information comprising transaction identification information, the execution information being configured to indicate that a plurality of transactions corresponding to the transaction identification information are to be executed in parallel by a secondary node;
generating write information comprising a write order of execution results, the write information being configured to indicate that execution results of the plurality of transactions are to be sequentially written by the secondary node into a transaction snapshot of the secondary node according to the write order; and
transmitting the execution information and the write information to the secondary node.

2. The method according to claim 1, wherein the generating execution information comprising transaction identification information and the generating write information comprising a write order of execution results comprises:
executing the plurality of transactions in parallel, and writing the execution results of the plurality of transactions that are obtained by executing the plurality of transactions in parallel into a transaction snapshot of the primary node;
obtaining a primary write order of writing the execution results of the plurality of transactions into the transaction snapshot of the primary node;
sequentially performing conflict detection on each of the plurality of transactions in the primary write order, to obtain a first conflict detection result of each of the plurality of transactions; and
generating the execution information and the write information based on the first conflict detection result.

3. The method according to claim 2, wherein the generating the execution information and the write information based on the first conflict detection result comprises:
in response to the first conflict detection result indicating that at least one of a read-write conflict or a write-read conflict exists between a first target transaction and a first previous transaction of the first target transaction, adding identification information of the first target transaction to a first sequence, and sequentially adding the identification information of the first target transaction to a second sequence, wherein a time point at which an execution result of a previous transaction of a target transaction is written into the transaction snapshot of the primary node is earlier than a time point at which the execution result of the target transaction is written into the transaction snapshot of the primary node;
in response to the first conflict detection result indicating that only a write-write conflict exists between a second target transaction and a second previous transaction of the second target transaction, sequentially adding the identification information of the second target transaction to the second sequence;
generating the execution information based on identification information of transactions comprised in the first sequence; and
generating the write information based on identification information and an arrangement order of transactions comprised in the second sequence.

4. The method according to claim 2, wherein the sequentially performing conflict detection on each of the plurality of transactions in the primary write order, to obtain a first conflict detection result of each of the plurality of transactions comprises:
obtaining a previous transaction of a target transaction in a process of performing conflict detection on the target transaction in the primary write order, wherein a time point at which an execution result of the previous transaction is written into the transaction snapshot of the primary node is earlier than a time point at which an execution result of the target transaction is written into the transaction snapshot of the primary node; and
detecting a conflict between the target transaction and the previous transaction, to obtain the first conflict detection result of the target transaction.

5. The method according to claim 4, wherein the detecting a conflict between the target transaction and the previous transaction, to obtain the first conflict detection result of the target transaction comprises:
obtaining a read-write set of the target transaction and a read-write set of the previous transaction; and
detecting the conflict between the target transaction and the previous transaction based on the read-write set of the target transaction and the read-write set of the previous transaction, to obtain the first conflict detection result of the target transaction.

6. The method according to claim 5, wherein a quantity of previous transactions of the target transaction is more than one; and
the obtaining a read-write set of the target transaction and a read-write set of the previous transaction comprises:
obtaining the read-write set of the target transaction and read-write sets of the plurality of previous transactions; and
the detecting the conflict between the target transaction and the previous transaction based on the read-write set of the target transaction and the read-write set of the previous transaction, to obtain the first conflict detection result of the target transaction comprises:
detecting conflicts between the target transaction and the plurality of previous transactions based on the read-write set of the target transaction and the read-write sets of the plurality of previous transactions, to obtain a plurality of first conflict detection results of the target transaction.

7. The method according to claim 2, wherein the writing the execution results of the plurality of transactions that are obtained by executing the plurality of transactions in parallel into a transaction snapshot of the primary node comprises:
in a process of writing the execution result of a target transaction into the transaction snapshot of the primary node, in response to detecting that a quantity of execution results that have been written into the transaction snapshot of the primary node changes, performing conflict detection on the target transaction, to obtain a second conflict detection result of the target transaction; and
re-executing the target transaction in response to the second conflict detection result indicating that the read-write conflict exists between the target transaction and a previous transaction of the target transaction, and writing an execution result obtained by re-executing the target transaction into the transaction snapshot of the primary node, wherein a time point at which an execution result of the previous transaction is written into the transaction snapshot of the primary node is earlier than a time point at which an execution result of the target transaction is written into the transaction snapshot of the primary node.

8. The method according to claim 2, further comprising:
obtaining a starting time point at which an execution result of a target transaction is written into the transaction snapshot of the primary node, and recording a first quantity of execution results that have been written into and that are read from the transaction snapshot of the primary node at the starting time point;
obtaining an ending time point at which the execution result of the target transaction is written into the transaction snapshot of the primary node, and recording a second quantity of execution results that have been written into and that are read from the transaction snapshot of the primary node at the ending time point; and
detecting, based on the first quantity and the second quantity, a quantity change of the execution results that have been written into the transaction snapshot of the primary node in the process of writing the execution result of the target transaction into the transaction snapshot of the primary node.

9. The method according to claim 8, wherein the detecting, based on the first quantity and the second quantity, a quantity change of the execution results that have been written into the transaction snapshot of the primary node in the process of writing the execution result of the target transaction into the transaction snapshot of the primary node comprises:
obtaining a first quantity detection result in response to the first quantity not matching the second quantity, wherein the first quantity detection result represents that in the process of writing the execution result of the target transaction into the transaction snapshot of the primary node, a quantity of execution results that have been written into the transaction snapshot of the primary node changes; and
obtaining a second quantity detection result in response to the first quantity matching the second quantity, wherein the second quantity detection result represents that in the process of writing the execution result of the target transaction into the transaction snapshot of the primary node, a quantity of execution results that have been written into the transaction snapshot of the primary node does not change.

10. The method according to claim 8, wherein the detecting, based on the first quantity and the second quantity, a quantity change of the execution results that have been written into the transaction snapshot of the primary node in the process of writing the execution result of the target transaction into the transaction snapshot of the primary node comprises:
recording a plurality of third quantities of the execution results that have been written into and that are respectively read from the transaction snapshot of the primary node in a time period between the starting time point and the ending time point;
selecting a maximum third quantity from the plurality of third quantities;
matching the first quantity with the selected third quantity, to obtain a first matching result;
matching the second quantity with the selected third quantity, to obtain a second matching result;
obtaining a first quantity detection result in response to at least one of the first matching result or the second matching result represents no matching, wherein the first quantity detection result represents that in the process of writing the execution result of the target transaction into the transaction snapshot of the primary node, the quantity of execution results that have been written into the transaction snapshot of the primary node changes; and
obtaining a second quantity detection result in response to both the first matching result and the second matching result represent matching, wherein the second quantity detection result represents that in the process of writing the execution result of the target transaction into the transaction snapshot of the primary node, the quantity of execution results that have been written into the transaction snapshot of the primary node does not change.

11. The method according to claim 7, wherein the performing conflict detection on the target transaction, to obtain a second conflict detection result of the target transaction comprises:
obtaining the previous transaction of the target transaction; and
detecting the conflict between the target transaction and the previous transaction, to obtain the second conflict detection result of the target transaction.

12. The method according to claim 11, wherein the detecting the conflict between the target transaction and the previous transaction, to obtain the second conflict detection result of the target transaction comprises:
obtaining, in response to detecting, based on the read-write set of the target transaction and the read-write set of the previous transaction, that the read-write conflict exists between the target transaction and the previous transaction, the second conflict detection result represents that the read-write conflict exists between the target transaction and the previous transaction; and
obtaining, in response to detecting, based on the read-write set of the target transaction and the read-write set of the previous transaction, that no read-write conflict exists between the target transaction and the previous transaction, a second conflict detection result represents that no read-write conflict exists between the target transaction and the previous transaction.

13. The method according to claim 1, wherein the transmitting the execution information and the write information to the secondary node comprises:
generating proposal information based on the execution information and the write information; and
transmitting the proposal information to the secondary node, to enable the secondary node to execute the plurality of transactions in parallel based on the execution information comprised in the proposal information, to obtain the execution results of the plurality of transactions, and sequentially writing the execution results of the plurality of transactions into the transaction snapshot of the secondary node based on the write information comprised in the proposal information.

14. A transaction processing method, performed by a computer device serving as a secondary node, the method comprising:
receiving execution information comprising transaction identification information and write information comprising a write order of execution results that are transmitted by a primary node;
executing, in parallel, a plurality of transactions corresponding to the transaction identification information, to obtain execution results of the plurality of transactions; and
sequentially writing the execution results of the plurality of transactions into a transaction snapshot of the secondary node in the write order.

15. The method according to claim 14, wherein the transaction identification information comprises identification information of the plurality of transactions; and the executing, in parallel, a plurality of transactions corresponding to the transaction identification information, to obtain execution results of the plurality of transactions comprises:
obtaining, based on the identification information of the plurality of transactions, transaction data of the plurality of transactions respectively corresponding to the identification information of the plurality of transactions; and
executing, in parallel, the transaction data respectively corresponding to the plurality of transactions, to obtain the execution results of the plurality of transactions.

16. A transaction processing apparatus, comprising:
one or more processors; and
a memory, configured to store one or more programs, the one or more programs, when executed by the one or more processors, causing the one or more processors to implement the transaction processing method according to claim 1.

17. A transaction processing apparatus, comprising:
one or more processors; and
a memory, configured to store one or more programs, the one or more programs, when executed by the one or more processors, causing the one or more processors to implement the transaction processing method according to claim 14.

18. A non-transitory computer-readable medium, having a computer program stored therein, the computer program, when executed by a processor of a primary node, causing the processor to implement:
generating execution information comprising transaction identification information, the execution information being configured to indicate that a plurality of transactions corresponding to the transaction identification information are to be executed in parallel by a secondary node;
generating write information comprising a write order of execution results, the write information being configured to indicate that execution results of the plurality of transactions are to be sequentially written by the secondary node into a transaction snapshot of the secondary node according to the write order; and
transmitting the execution information and the write information to the secondary node.

19. The storage medium according to claim 18, wherein the generating execution information comprising transaction identification information and the generating write information comprising a write order of execution results comprises:
executing the plurality of transactions in parallel, and writing the execution results of the plurality of transactions that are obtained by executing the plurality of transactions in parallel into a transaction snapshot of the primary node;
obtaining a primary write order of writing the execution results of the plurality of transactions into the transaction snapshot of the primary node;
sequentially performing conflict detection on each of the plurality of transactions in the primary write order, to obtain a first conflict detection result of each of the plurality of transactions; and
generating the execution information and the write information based on the first conflict detection result.

20. The storage medium according to claim 19, wherein the generating the execution information and the write information based on the first conflict detection result comprises:
in response to the first conflict detection result indicating that at least one of a read-write conflict or a write-read conflict exists between a first target transaction and a first previous transaction of the first target transaction, adding identification information of the first target transaction to a first sequence, and sequentially adding the identification information of the first target transaction to a second sequence, wherein a time point at which an execution result of a previous transaction of a target transaction is written into the transaction snapshot of the primary node is earlier than a time point at which the execution result of the target transaction is written into the transaction snapshot of the primary node;
in response to the first conflict detection result indicating that only a write-write conflict exists between a second target transaction and a second previous transaction of the second target transaction, sequentially adding the identification information of the second target transaction to the second sequence;
generating the execution information based on identification information of transactions comprised in the first sequence; and
generating the write information based on identification information and an arrangement order of transactions comprised in the second sequence.
